(19) United States
(12) Patent Application Publication
(10) Pub. No.: US 2026/0252310 A1
(43) Pub. Date: Aug. 27, 2026

(54) Polynomial Calculation Method and Apparatus

(71) Applicant: HUAWEI TECHNOLOGIES CO., LTD., Shenzhen (CN)

(72) Inventors: Qian Cheng, Shenzhen (CN); Wei Ying, Hangzhou (CN); Jinting Wang, Hangzhou (CN); Yu He, Shenzhen (CN)

(73) Assignee: HUAWEI TECHNOLOGIES CO., LTD., Shenzhen (CN)

(21) Appl. No.: 19/644,421

(22) Filed: Apr. 10, 2026

Related U.S. Application Data
(63) Continuation of application No. PCT/CN2024/100201, filed on Jun. 19, 2024.

(30) Foreign Application Priority Data
Oct. 12, 2023 (CN) 202311323154.X

(51) Int. Cl. G06F 7/523; G06F 7/535

(52) U.S. Cl. CPC G06F 7/523; G06F 7/535

(57) ABSTRACT

A polynomial calculation method includes: obtaining a plurality of to-be-calculated polynomials in a polynomial calculation application; dividing the plurality of to-be-calculated polynomials to obtain a plurality of to-be-calculated groups, where the plurality of to-be-calculated groups include a first to-be-calculated group; loading a common variable, a variable coefficient, and a reference variable that correspond to at least one to-be-calculated polynomial in the first to-be-calculated group respectively to at least one first register group, at least one second register group, and at least one third register group; controlling outer product calculation to be performed on the common variable in the at least one first register group and the variable coefficient in the at least one second register group, to obtain a first result; and controlling inner product calculation to be performed on the first result and the reference variable in the at least one third register group, to obtain a second result.

### CROSS-REFERENCE TO RELATED APPLICATIONS

This is a continuation of International Patent Application No. PCT/CN2024/100201 filed on Jun. 19, 2024, which claims priority to Chinese Patent Application No. 202311323154.X filed on Oct. 12, 2023. The disclosures of the aforementioned applications are hereby incorporated by reference in their entireties.

### TECHNICAL FIELD

The present disclosure relates to the field of chip technologies, and in particular, to a polynomial calculation method and apparatus.

### BACKGROUND

In mathematics, a polynomial includes a sum/difference of a plurality of monomials, where each monomial is an expression formed by a variable, a variable coefficient, and multiplication and exponentiation (nonnegative integer power) operations therebetween. At present, polynomial calculation typically involves calculating the value of each monomial and then obtaining a result of the polynomial based on the sum/difference of the plurality of monomials. When a large quantity of polynomials need to be calculated, the foregoing calculation approach causes significant time overheads. Improving polynomial calculation efficiency is an urgent problem to be addressed.

### SUMMARY

The present disclosure provides a polynomial calculation method and apparatus, to improve a polynomial calculation speed.

According to a first aspect, the present disclosure provides a polynomial calculation method. The method may be performed by a device (for example, a compute device) having a data processing function, or may be performed by a component (for example, a processor) in the device. The compute device is used as an example. In the method, a plurality of to-be-calculated polynomials in a polynomial calculation application are obtained. The plurality of to-be-calculated polynomials are divided to obtain a plurality of to-be-calculated groups, where each to-be-calculated group includes at least one to-be-calculated polynomial, the at least one to-be-calculated polynomial in each to-be-calculated group has a same variable coefficient, the plurality of to-be-calculated groups include a first to-be-calculated group, and the first to-be-calculated group is any to-be-calculated group in the plurality of to-be-calculated groups. A respective common variable, a respective variable coefficient, and a respective reference variable that correspond to each of at least one to-be-calculated polynomial in the first to-be-calculated group are determined. The respective common variable corresponding to each of the at least one to-be-calculated polynomial is loaded to at least one first register group, the respective variable coefficient corresponding to each of the at least one to-be-calculated polynomial is loaded to at least one second register group, and the respective reference variable corresponding to each of the at least one to-be-calculated polynomial is loaded to at least one third register group. Outer product calculation is controlled to be performed on the common variable in the at least one first register group and the variable coefficient in the at least one second register group, to obtain a first result corresponding to each of the at least one to-be-calculated polynomial. Inner product calculation is controlled to be performed on the first result corresponding to each of the at least one to-be-calculated polynomial and the reference variable in the at least one third register group, to obtain a second result corresponding to each of the at least one to-be-calculated polynomial. When a large number of polynomials are calculated, according to the foregoing method, polynomial cyclic calculation may be converted into matrix calculation between register groups, improving a calculation speed.

In a possible design, the determining the common variable, the variable coefficient, and the reference variable that correspond to the at least one to-be-calculated polynomial in the first to-be-calculated group may include: performing the following steps for a first polynomial in the at least one to-be-calculated polynomial, where the first polynomial is any polynomial in the at least one to-be-calculated polynomial: extracting, from the first polynomial, M Nth-degree polynomials and M reference variables corresponding to the M Nth-degree polynomials, where the M Nth-degree polynomials are in one-to-one correspondence with the M reference variables, each Nth-degree polynomial includes N common variables and N variable coefficients, the N common variables are in one-to-one correspondence with the N variable coefficients, the N common variables included in each of the M Nth-degree polynomials are the same as those included in another one in the M Nth-degree polynomials, M is a positive integer, and N is an integer greater than 1; and determining the N common variables and M*N variable coefficients based on the M Nth-degree polynomials.

In a possible design, before the extracting, from the first polynomial, the M Nth-degree polynomials and the M reference variables corresponding to the M Nth-degree polynomials, the method may further include: when it is determined that orders of monomials included in the first polynomial are non-consecutive, supplementing the first polynomial with a monomial corresponding to a missing degree, where a variable coefficient of the monomial corresponding to the missing degree is zero. According to this design, a supplemented first polynomial may be obtained, where orders of monomials in the supplemented first polynomial are consecutive. This facilitates subsequent polynomial calculation.

In a possible design, before the extracting, from the first polynomial, the M Nth-degree polynomials and the M reference variables corresponding to the M Nth-degree polynomials, the method may further include: when it is determined that a number of monomials included in the first polynomial is odd, supplementing the first polynomial with an odd number of monomials, where variable coefficients of the odd number of monomials are all zero. According to this design, a supplemented first polynomial may be obtained, where orders of monomials in the supplemented first polynomial are consecutive, and a number of the monomials is even. This facilitates subsequent polynomial calculation.

In a possible design, the extracting, from the first polynomial, the M Nth-degree polynomials and the M reference variables corresponding to the M Nth-degree polynomials may include: first using every N monomials of adjacent orders in the first polynomial as one second polynomial, to obtain M second polynomials; then, determining respective ratios of a kth variable included in each of the M second polynomials to a kth variable included in a second polynomial of a lowest degree, as M reference variables corresponding to the M second polynomials, where k is a nonnegative integer less than N; and finally, determining ratios of each of the M second polynomials to the corresponding reference variables as the M Nth-degree polynomials. According to this design, a method for obtaining the M Nth-degree polynomials and the M reference variables is provided.

In a possible design, the loading the respective common variable corresponding to each of the at least one to-be-calculated polynomial to the at least one first register group, loading the respective variable coefficient corresponding to each of the at least one to-be-calculated polynomial to the at least one second register group, and loading the respective reference variable corresponding to each of the at least one to-be-calculated polynomial to the at least one third register group may include: performing the following steps for the first polynomial in the at least one to-be-calculated polynomial, where the first polynomial is any polynomial in the at least one to-be-calculated polynomial: loading the N common variables corresponding to the first polynomial to a first destination register group, where the first destination register group is any one of the at least one first register group; loading the M*N variable coefficients corresponding to the first polynomial to a second destination register group, where the second destination register group is any one of the at least one second register group; and loading the M reference variables corresponding to the first polynomial to a third destination register group, where the third destination register group is any one of the at least one third register group.

In a possible design, the first destination register group includes a plurality of first registers, and each first register includes a plurality of storage locations. The loading the N common variables corresponding to the first polynomial to the first destination register group may include: loading an ith common variable in the N common variables to a jth storage location in a (b+i)th first register in the first destination register group, where i is an integer in [0, N−1], j is a nonnegative integer, and b is a nonnegative integer. According to this design, a method for loading the common variable is provided.

In a possible design, the second destination register group includes a plurality of second registers, and each second register includes a plurality of storage locations. The loading the M*N variable coefficients corresponding to the first polynomial to the second destination register group may include: loading an ith variable coefficient corresponding to an mth Nth-degree polynomial in the M Nth-degree polynomials to a (b+m)th storage location in a (b+i)th second register in the second destination register group, where m is an integer in [0, M−1], i is an integer in [0, N−1], and b is a nonnegative integer. According to this design, a method for loading the variable coefficient is provided.

In a possible design, the third destination register group includes a plurality of third registers, and each third register includes a plurality of storage locations. The loading the M reference variables corresponding to the first polynomial to the third destination register group may include: loading an mth reference variable in the M reference variables to a jth storage location in a (b+m)th third register in the third destination register group, where m is an integer in [0, M−1], b is a nonnegative integer, and j is a nonnegative integer. According to this design, a method for loading the reference variable is provided.

In a possible design, the controlling outer product calculation to be performed on the common variable in the at least one first register group and the variable coefficient in the at least one second register group, to obtain the first result corresponding to each of the at least one to-be-calculated polynomial may include: performing the following step for the first polynomial in the at least one to-be-calculated polynomial, where the first polynomial is any polynomial in the at least one to-be-calculated polynomial: controlling outer product calculation to be performed on the common variable in the first destination register group and the variable coefficient in the second destination register group, to obtain a first result corresponding to the first polynomial.

In a possible design, the controlling inner product calculation to be performed on the first result corresponding to each of the at least one to-be-calculated polynomial and the reference variable in the at least one third register group, to obtain the second result corresponding to each of the at least one to-be-calculated polynomial may include: performing the following step for the first polynomial in the at least one to-be-calculated polynomial, where the first polynomial is any polynomial in the at least one to-be-calculated polynomial: controlling inner product calculation to be performed on the first result corresponding to the first polynomial and the reference variable in the third destination register group, to obtain a second result corresponding to the first polynomial.

According to a second aspect, an embodiment of the present disclosure provides a polynomial calculation apparatus. The apparatus has a function of implementing a behavior of the compute device in any one of the first aspect and the possible implementation method examples of the first aspect. For beneficial effects, refer to the descriptions of the first aspect. The function may be implemented by hardware, or may be implemented by executing corresponding software by hardware. The hardware or the software includes one or more modules corresponding to the foregoing function. In a possible design, a structure of the apparatus includes an obtaining module and a processing module. These modules may have functions of performing the behavior of the compute device in any one of the first aspect and the possible implementation method examples of the first aspect. For details, refer to the detailed descriptions in the method examples.

According to a third aspect, an embodiment of the present disclosure provides a compute device. The compute device has a function of implementing a behavior of the compute device in any one of the first aspect and the possible implementation method examples of the first aspect. For beneficial effects, refer to the descriptions of the first aspect. A structure of the compute device includes a processor and a storage. The processor is configured to support the compute device in performing a corresponding function of the compute device in the method examples in the first aspect. The storage is coupled to the processor, and stores program instructions and data that are necessary for the compute device. The structure of the compute device further includes a communication interface configured to communicate with another device.

According to a fourth aspect, the present disclosure further provides a computer-readable storage medium. The computer-readable storage medium stores instructions. When the instructions are run on a computer, the computer is enabled to perform the method in the first aspect and the possible implementations of the first aspect.

According to a fifth aspect, the present disclosure further provides a computer program product including instructions. When the computer program product runs on a computer, the computer is enabled to perform the method in the first aspect and the possible implementations of the first aspect, or the computer is enabled to perform the method in the first aspect and the possible implementations of the first aspect.

According to a sixth aspect, the present disclosure further provides a computer chip. The chip is connected to a storage. The chip is configured to read and execute a software program stored in the storage, to perform the method in the first aspect and the possible designs of the first aspect, or to enable a computer to perform the method in the first aspect and the possible implementations of the first aspect.

### BRIEF DESCRIPTION OF DRAWINGS

FIG. 1 is a diagram of a structure of a compute device according to an embodiment of the present disclosure;

FIG. 2 is a schematic flowchart of a polynomial calculation method according to an embodiment of the present disclosure;

FIG. 3 is a schematic flowchart of a polynomial calculation method according to an embodiment of the present disclosure;

FIG. 4 is a diagram of a structure of a first register group according to an embodiment of the present disclosure;

FIG. 5 is a diagram of a structure of a first register group according to an embodiment of the present disclosure;

FIG. 6 is a diagram of a structure of a second register group according to an embodiment of the present disclosure;

FIG. 7 is a diagram of a structure of a second register group according to an embodiment of the present disclosure;

FIG. 8 is a diagram of a structure of a third register group according to an embodiment of the present disclosure;

FIG. 9 is a diagram of a structure of a third register group according to an embodiment of the present disclosure;

FIG. 10 is a diagram of a structure of a first register group according to an embodiment of the present disclosure;

FIG. 11 is a diagram of a structure of a second register group according to an embodiment of the present disclosure;

FIG. 12 is a diagram of a structure of a third register group according to an embodiment of the present disclosure;

FIG. 13 is a diagram of a structure of a fourth register group according to an embodiment of the present disclosure;

FIG. 14 is a diagram of a structure of a fourth register group according to an embodiment of the present disclosure;

FIG. 15 is a diagram of a structure of a fifth register group according to an embodiment of the present disclosure;

FIG. 16 is a diagram of a structure of a fifth register group according to an embodiment of the present disclosure; and

FIG. 17 is a diagram of a structure of a compute device according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings. Specific operation methods, function descriptions, and the like in method embodiments may also be applied to apparatus embodiments or system embodiments.

To better explain embodiments of the present disclosure, related terms or technologies in the present disclosure are first explained.

### 1. Row Vector

The row vector is a 1×p matrix, where p is any positive integer, for example, x=[x₁ x₂ . . . x_{P}].

### 2. Column Vector

The column vector is a q×1 matrix, where q is any positive integer, for example,

$$x = [ \begin{matrix}{x}_{1} \\ {x}_{2} \\ … \\ {x}_{q}\end{matrix} ] .$$

### 3. Matrix Size/Scale

A p×q matrix is a rectangular array formed by arranging p rows and q columns of elements. An example is as follows:

$$A = [ \begin{matrix}{A}_{11} & {A}_{12} & … & {A}_{1 q} \\ {A}_{21} & {A}_{22} & … & {A}_{2 q} \\ … & … & … & … \\ {A}_{p 1} & {A}_{p 2} & … & {A}_{pq}\end{matrix} ]$$

Each number that constitutes a matrix is referred to as an element in the matrix. For example, A₁₁, A₁₂, . . . , and A_{pq} are all elements in the matrix A. A subscript (or referred to as coordinates) of an element indicates a location of the element in the matrix, and may be a row index (or referred to as a row coordinate) or a column index (or referred to as a column coordinate) of the element in the matrix. For example, a subscript “11” of A₁₁ indicates that the element is located in a 1^{st} row and a 1^{st} column of the matrix A, and a subscript “21” of A₂₁ indicates that the element is located in a 2^{nd} row and the 1^{st} column of the matrix A. In addition, the subscript of the element may alternatively have a different representation form. For example, A₁₁ may alternatively be written as A_{1,1}, and A₂₁ may alternatively be written as A_{2,1}. Similar parts are not described in the following.

It should be noted that a row index of a start row of a matrix is not limited to 1, and may alternatively be another value like 0. Similarly, a column index of a start column of the matrix is not limited to 1, and may alternatively be other data like 0. For example, if the row index of the start row and the column index of the start column of the matrix are 0 and 0, a subscript of an initial element in the matrix is “00”, indicating that the element is in a 0^{th} row and a 0^{th} column of the matrix.

### 4. Matrix Addition

Matrix addition means adding two matrices with a same scale (or referred to as a same size, that is, the two matrices have a same number of rows and a same number of columns). For example, both A and B are p×q matrices, and a matrix C=A+B.

$$\begin{matrix}A = [ \begin{matrix}{A}_{11} & {A}_{12} & … & {A}_{1 q} \\ {A}_{21} & {A}_{22} & … & {A}_{2 q} \\ … & … & … & … \\ {A}_{p 1} & {A}_{p 2} & … & {A}_{pq}\end{matrix} ] B = [ \begin{matrix}{B}_{11} & {B}_{12} & … & {B}_{1 q} \\ {B}_{21} & {B}_{22} & … & {B}_{2 q} \\ … & … & … & … \\ {B}_{p 1} & {B}_{p 2} & … & {B}_{pq}\end{matrix} ] \\ C = A + B = [ \begin{matrix}{A}_{11} + {B}_{11} & {A}_{12} + {B}_{12} & … & {A}_{1 q} + {B}_{1 q} \\ {A}_{21} + {B}_{21} & {A}_{22} + {B}_{22} & … & {A}_{2 q} + {B}_{2 q} \\ … & … & … & … \\ {A}_{p 1} + {B}_{p 1} & {A}_{p 2} + {B}_{p 2} & … & {A}_{pq} + {B}_{pq}\end{matrix} ]\end{matrix}$$

Similarly, matrix subtraction means subtracting elements at each same location in the two matrices with the same scale from each other.

### 5. Matrix Multiplication

For two matrices (for example, matrices D and E) to be multiplied, a number of columns of D needs to be the same as a number of rows of E. For example, if D is a p×q matrix and E is a q×s matrix, a product of D and E is a p×s matrix. An example is as follows:

$$\begin{matrix}D = [ \begin{matrix}{a}_{11} & {a}_{12} & {a}_{13} \\ {a}_{21} & {a}_{22} & {a}_{23}\end{matrix} ] E = [ \begin{matrix}{b}_{11} & {b}_{12} \\ {b}_{21} & {b}_{22} \\ {b}_{31} & {b}_{32}\end{matrix} ] \\ F = DE = [ \begin{matrix}{a}_{11} {b}_{11} + {a}_{12} {b}_{21} + {a}_{13} {b}_{31} & {a}_{11} {b}_{12} + {a}_{12} {b}_{22} + {a}_{13} {b}_{32} \\ {a}_{21} {b}_{11} + {a}_{22} {b}_{21} + {a}_{23} {b}_{23} & {a}_{21} {b}_{12} + {a}_{22} {b}_{22} + {a}_{23} {b}_{32}\end{matrix} ]\end{matrix}$$

The following describes in detail the technical solutions provided in embodiments of the present disclosure with reference to the accompanying drawings.

FIG. 1 is a diagram of a compute device according to the present disclosure. The compute device 100 includes a processor 101 and a storage 102. Optionally, the compute device 100 may further include a communication interface 104 and a matrix operator 106. The processor 101, the storage 102, the matrix operator 106, and the communication interface 104 may be connected to each other through a communication line 105. The communication line 105 may be a Peripheral Component Interconnect (PCI) bus, an Extended Industry Standard Architecture (EISA) bus, or the like. The communication line 105 may be classified into an address bus, a data bus, a control bus, and the like. For ease of representation, only one bold line is used for representation in FIG. 1, but this does not mean that there is only one bus or one type of bus.

The processor 101 may be a central processing unit (CPU), an application-specific integrated circuit (ASIC), a field-programmable gate array (FPGA), an artificial intelligence (AI) chip, a system on a chip (SoC) or complex programmable logic device (CPLD), a graphics processing unit (GPU), a neural network processing module (NPU), a microprocessor, one or more integrated circuits configured to control program execution of the solutions of the present disclosure, or the like.

It should be noted that FIG. 1 shows only one processor 101. In actual application, there may be a plurality of processors 101. The plurality of processors 101 may include a plurality of processors of a same type, or may include a plurality of processors of different types. For example, the plurality of processors 101 include a plurality of CPUs. For another example, the plurality of processors 101 include at least one CPU, at least one GPU, and the like. One CPU further has one or more CPU cores. A number of processors 101, a number of CPU cores, and the like are not limited in this embodiment.

Specifically, the processor 101 is configured to process a data access request from outside (for example, another compute device) of the compute device 100, and is also configured to process a request generated inside the compute device 100. For example, the request is a data write request, and the data write request includes a polynomial. After receiving the data write request, the processor 101 may perform a polynomial calculation method provided in embodiments of the present disclosure, to process the polynomial and store processed data in the storage 102. For another example, the request may be a data read request, the data read request is used to request to read polynomial data, and the polynomial data may include a part or all of the polynomial. After receiving the data read request, the processor 101 reads the polynomial data from the storage 102.

In addition, the processor 101 is further configured to perform other data calculation or processing, for example, a matrix operation. This is not specifically limited. Optionally, the matrix operation may alternatively be allocated to the matrix operator 106 for execution. In some cases, when the processor 101 has a plurality of cores, the compute device 100 includes the plurality of processors 101, or the compute device 100 includes a plurality of matrix operators 106, the plurality of cores, the plurality of processors 101, or the plurality of matrix operators 106 may perform the matrix operation in parallel. Details are not emphasized herein.

The matrix operator 106 may be configured to process the matrix operation. Refer to the foregoing descriptions of the matrix operations. The matrix operator 106 may include but is not limited to a vector processor (VP), a vector processor system (VPS), a matrix processor, a matrix accelerator, and the like. This is not specifically limited.

The communication interface 104 uses any apparatus like a transceiver, and is configured to communicate with another device or a communication network such as an Ethernet, a radio access network (RAN), a wireless local area network (WLAN), or a wired access network, for example, obtain a data read request and a data write request.

The storage 102 is configured to store data and computer-executable program code. For example, the data includes but is not limited to polynomial data. The executable program code may include program code of the polynomial calculation method provided in embodiments of the present disclosure. The processor 101 executes the executable program code to implement the polynomial calculation method provided in this embodiment. In other words, the storage 102 stores computer-executable instructions for executing the solutions of the present disclosure, and the processor 101 controls the execution. The processor 101 is configured to execute the computer-executable instructions stored in the storage 102, to implement the polynomial calculation method provided in the foregoing embodiments of the present disclosure.

The storage 102 may exist independently, and is connected to the processor through the communication line 105. Alternatively, the storage 102 may be integrated with the processor. Specifically, for example, the storage 102 may include a memory, and may further include a hard disk. The memory is an internal storage that directly exchanges data with the processor 101. Data can be read and written in the memory at a high speed at any time, and the memory serves as a temporary data storage of an operating system or another running program. Different from the memory, the hard disk has a lower speed of reading and writing data than the memory, and is usually configured to store data persistently. In some application scenarios, the processor 101 may temporarily store data in the memory. When a total amount of data in the memory reaches a specific threshold, the processor 101 sends the data stored in the memory to the hard disk for persistent storage. The data may be obtained from an external device, input by a user, or generated by the compute device 100. This is not specifically limited. Alternatively, the processor 101 reads the data from the memory. When the memory is not hit, the processor 101 reads the data from the hard disk into the memory, and then reads the data from the memory.

The memory includes at least two types of storages. For example, the memory may be a random-access memory (RAM), or may be a read-only memory (ROM). For example, the RAM is a dynamic RAM (DRAM) or a storage class memory (SCM). The memory may further include another RAM, for example, a static RAM (SRAM). The ROM may be, for example, a programmable ROM (PROM) or an erasable PROM (EPROM). In addition, the memory may alternatively be a dual-line memory module (DIMM), that is, a module including DRAMs. In actual application, a plurality of memories and different types of memories may be configured in the compute device 100. A number of memories and a type of the memory are not limited in this embodiment.

The hard disk may be specifically a magnetic disk or another type of storage medium, for example, a solid-state drive (SSD), a hard disk (HDD), a shingled magnetic recording compact disc ROM (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of an instruction or a data structure and that can be accessed by a computer. However, this is not limited thereto.

It should be noted that the structure of the compute device 100 shown in FIG. 1 is merely an example. In actual application, the compute device 100 may have more or fewer components. For example, the compute device 100 may further include input/output devices such as a keyboard, a mouse, and a display. This is not limited in embodiments of the present disclosure.

The following describes in detail the polynomial calculation method provided in embodiments of the present disclosure by using an example in which the polynomial calculation method is applied to the compute device shown in FIG. 1.

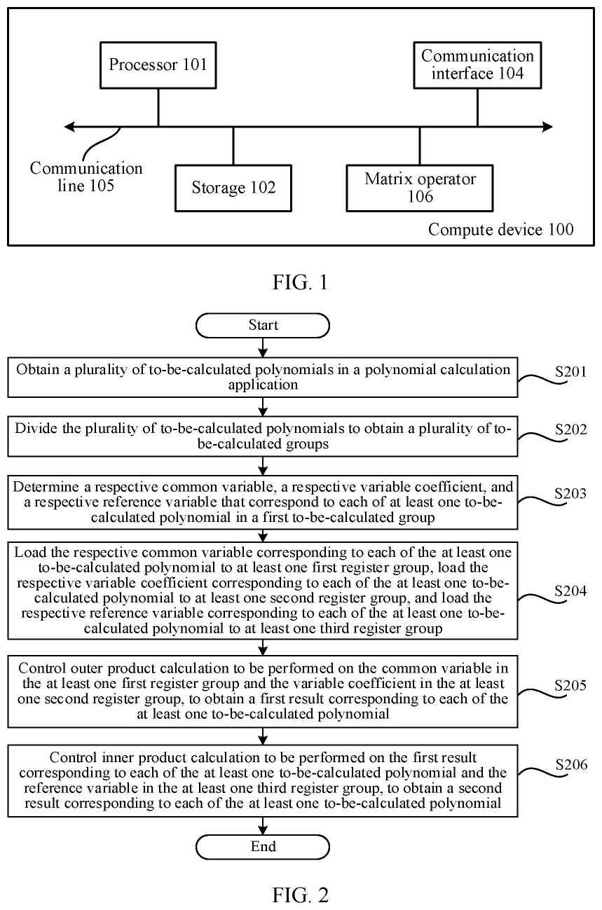

FIG. 2 is a schematic flowchart corresponding to a polynomial calculation method according to an embodiment of the present disclosure. The method may be performed by a compute device (for example, the compute device 100) having a data processing capability, or may be performed by a component, for example, the processor 101 or the matrix operator 106, of the compute device. For ease of description, the following uses the compute device 100 as an example for description. As shown in FIG. 2, the method includes the following steps.

S201: Obtain a plurality of to-be-calculated polynomials in a polynomial calculation application.

In this embodiment of the present disclosure, the to-be-calculated polynomial includes one basic variable. The to-be-calculated polynomial includes at least two monomials. Each monomial in the to-be-calculated polynomial includes the same basic variable. The to-be-calculated polynomial may include a sum/difference of the at least two monomials, where each monomial is an expression obtained by using a basic variable, a variable coefficient, and multiplication and power (nonnegative integer power) operations therebetween.

For example, the to-be-calculated polynomial is a₁x¹+a₂x²+a₄x⁴, where a₁x¹, a₂x², and a₄x⁴ are all monomials, a₁, a₂, and a₄ are variable coefficients, and x is a basic variable. a₁, a₂, a₄, and x each may be any known value.

For ease of description in the following, when the to-be-calculated polynomial includes the sum/difference of the at least two monomials, the to-be-calculated polynomial may be adjusted, so that the adjusted to-be-calculated polynomial includes the sum of the at least two monomials. The adjusted to-be-calculated polynomial facilitates subsequent polynomial calculation. For example, the to-be-calculated polynomial is 2x¹+3x²-4x³, the to-be-calculated polynomial may be adjusted, and the adjusted to-be-calculated polynomial is 2x¹+3x²+(−4x³).

S202: Divide the plurality of to-be-calculated polynomials to obtain a plurality of to-be-calculated groups.

In this embodiment of the present disclosure, to-be-calculated polynomials with a same variable coefficient may be grouped into one to-be-calculated group. Each to-be-calculated group includes at least one to-be-calculated polynomial, and the at least one to-be-calculated polynomial in each to-be-calculated group has a same variable coefficient.

The plurality of to-be-calculated groups include a first to-be-calculated group, where the first to-be-calculated group is any to-be-calculated group in the plurality of to-be-calculated groups. The following uses the first to-be-calculated group as an example for description.

S203: Determine a respective common variable, a respective variable coefficient, and a respective reference variable that correspond to each of at least one to-be-calculated polynomial in the first to-be-calculated group.

In this embodiment of the present disclosure, the at least one to-be-calculated polynomial includes a first polynomial, where the first polynomial is any polynomial in the at least one to-be-calculated polynomial. The following uses the first polynomial as an example for description.

Before a common variable, a variable coefficient, and a reference variable that correspond to the first polynomial are determined, whether degrees of monomials included in the first polynomial are consecutive may be first determined. When it is determined that the degrees of the monomials included in the first polynomial are non-consecutive, the first polynomial is supplemented with a monomial corresponding to a missing degree, where a variable coefficient of the monomial corresponding to the missing degree is zero. Then, it is determined whether a number of monomials included in the first polynomial is odd. When it is determined that the number of monomials included in the first polynomial is odd, the first polynomial is supplemented with an odd number of monomials, where variable coefficients of the odd number of monomials are all zero. After the first polynomial is supplemented with the odd number of monomials, degrees of monomials included in a supplemented first polynomial are still consecutive. In the foregoing manner, the supplemented first polynomial may be obtained, where the degrees of the monomials in the supplemented first polynomial are consecutive, and a number of the monomials is even. This facilitates subsequent polynomial calculation.

It should be understood that to improve a speed of subsequent polynomial calculation, when it is determined that the number of monomials included in the first polynomial is odd, the first polynomial is supplemented with one monomial, where a variable coefficient of the monomial supplemented is zero. For ease of subsequent discussion, the following uses an example in which the first polynomial is supplemented with one monomial for description.

For example, if the obtained first polynomial is a₁x¹+a₃x³, and degrees of two monomials included in the first polynomial are 1 and 3, the degrees of the two monomials are non-consecutive, and a second-degree monomial is missing. Therefore, the first polynomial is supplemented with the second-degree monomial, to update the first polynomial to a₁x¹+a₂x²+a₃x³, where a₂ is 0.

The first polynomial a₁x¹+a₂x²+a₃x³ includes three monomials, a number of the monomials included is odd, and a₁x¹+a₂x²+a₃x³ may be supplemented with one monomial. In one case, a₁x¹+a₂x²+a₃x³ may be supplemented with a₀x⁰, to update the first polynomial to a₀x⁰+a₁x¹+a₂x²+a₃x³, where a₀ is 0. In another case, a₁x¹+a₂x²+a₃x³ may be supplemented with a₄x⁴, to update the first polynomial to a₁x¹+a₂x²+a₃x³+a₄x⁴, where a₄ is 0.

When it is determined that the degrees of the monomials in the first polynomial are consecutive and the number of the monomials is even, the following steps are performed: first extracting, from the first polynomial, M N^{th}-degree polynomials and M reference variables corresponding to the M N^{th}-degree polynomials, and then determining N common variables and M*N variable coefficients based on the M N^{th}-degree polynomials, where M is a positive integer, and N is an integer greater than 1.

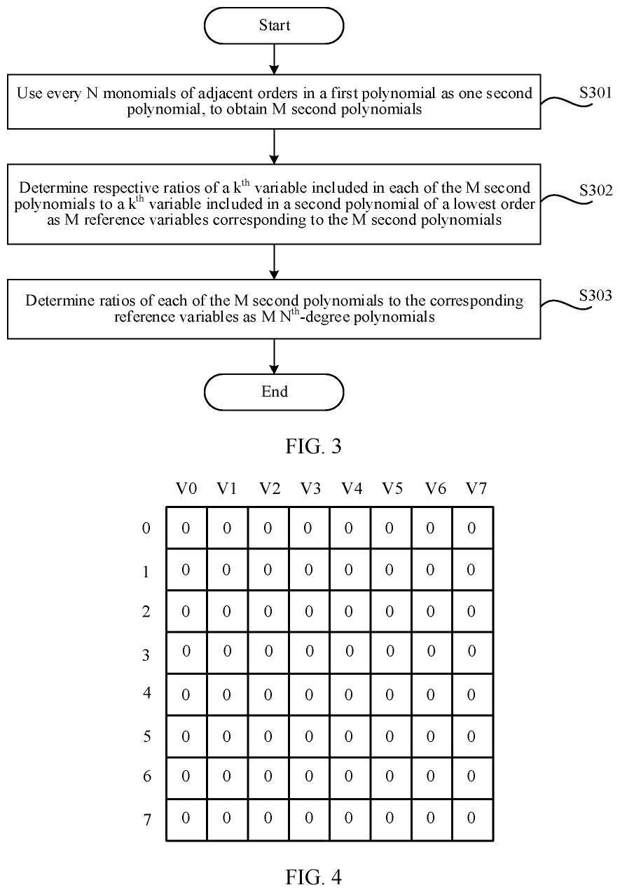

In this embodiment of the present disclosure, the M N^{th}-degree polynomials and the M reference variables corresponding to the M N^{th}-degree polynomials may be extracted from the first polynomial in the following possible implementations, which includes the following steps shown in FIG. 3.

S301: Use every N monomials of adjacent degrees in the first polynomial as one second polynomial, to obtain M second polynomials.

In this embodiment of the present disclosure, the number of monomials in the first polynomial is N*M, where N may be an integer greater than 1, N is less than the number of monomials in the first polynomial, M is a positive integer, and * represents multiplication. Details are not described below. For example, the first polynomial is a₁x¹+a₂x²+a₃x³+a₄x⁴+a₅x⁵+a₆x⁶, and N is set to 3. Based on the foregoing first polynomial, two second polynomials a₁x¹+a₂x²+a₃x³ and a₄x⁴+a₅x⁵+a₆x⁶ may be obtained, where each second polynomial includes three monomials of adjacent degrees.

In this embodiment of the present disclosure, in a case in which the first polynomial is determined, numbers M of second polynomials obtained when N has different values are different. The value of N may be determined in the following two possible implementations.

In a first possible implementation, one of available values corresponding to N may be randomly selected as the value of N.

For example, if the available values of N are 2 and 3, 2 is randomly selected as the value of N.

In a second possible implementation, division results corresponding to available values of N are determined, where the division result includes the M second polynomials. Then, execution duration corresponding to different division results is determined, and a value corresponding to a division result with smallest execution duration is selected as the value of N. The execution duration corresponding to the division result includes execution duration required for obtaining results corresponding to the M second polynomials and execution duration required for obtaining a sum of the M second polynomials.

A result of each of the M second polynomials is obtained through inner product calculation. Therefore, execution duration required for obtaining the result of each second polynomial is duration corresponding to inner product calculation. Obtaining the sum of the M second polynomials requires M−1 accumulation operations. Therefore, the execution duration required for obtaining the sum of the M second polynomials is duration of M−1 accumulation operations. Specifically, the execution duration for obtaining the sum of the M second polynomials is equal to (M−1)*Duration of an accumulation operation.

For example, the first polynomial is a₁x¹+a₂x²+a₃x³+a₄x⁴+a₅x⁵+a₆x⁶, the number of monomials in the first polynomial is 6, and the available value of N is 2 or 3. It is set that duration corresponding to first inner product calculation is t1, where first inner product calculation may be understood as inner product calculation performed on two 2×2 matrices; duration corresponding to second inner product calculation is t2, where the second inner product calculation may be understood as inner product calculation performed on two 3×3 matrices; and the duration of an accumulation operation is t3.

When the value of N is 2, the first polynomial is divided to obtain a first division result, where the first division result includes three second polynomials, that is, a₁x¹+a₂x², a₃x³+a₄x⁴, and a₅x⁵+a₆x⁶. A result of each second polynomial is obtained through inner product calculation. Therefore, execution duration required for obtaining the result of each second polynomial is t1, and execution duration required for obtaining the results of the foregoing three second polynomials is 3*t1. Obtaining a sum of the three second polynomials requires two accumulation operations. Therefore, execution duration for obtaining the sum of the three second polynomials is 2*t3. Consequently, execution duration corresponding to the first division result is equal to 3*t1+2*t3.

When the value of N is 3, the first polynomial is divided to obtain a second division result, where the second division result includes two second polynomials, that is, a₁x¹+a₂x²+a₃x³ and a₄x⁴+a₅x⁵+a₆x⁶. A result of each second polynomial is obtained through inner product calculation. Therefore, execution duration required for obtaining the result of each second polynomial is t2, and execution duration required for obtaining the results of the foregoing two second polynomials is 2*t2. Obtaining a sum of the two second polynomials requires one accumulation operation. Therefore, execution duration for obtaining the sum of the two second polynomials is t3. Consequently, execution duration corresponding to the second division result is equal to 2*t2+t3.

The execution duration corresponding to the first division result is 3*t1+2*t3, and the execution duration corresponding to the second division result is 2*t2+t3. Based on comparison between the two pieces of execution duration, if 3*t1+2*t3 is less than 2*t2+t3, the value of N is 2; if 3*t1+2*t3 is greater than 2*t2+t3, the value of N is 3; or if 3*t1+2*t3 is equal to 2*t2+t3, the value of N is 2 or 3.

S302: Determine respective ratios of a k^{th} variable included in each of the M second polynomials to a k^{th} variable included in a second polynomial of a lowest degree, as M reference variables corresponding to the M second polynomials, where k is a nonnegative integer less than N.

S303: Determine ratios of each of the M second polynomials to the corresponding reference variables as the M N^{th}-degree polynomials.

In this embodiment of the present disclosure, it can be learned from the steps in FIG. 3 that the first polynomial may be decomposed into the M N^{th}-degree polynomials and the M reference variables, where the M N^{th}-degree polynomials are in one-to-one correspondence with the M reference variables.

For example, the first polynomial is a₁x¹+a₂x²+a₃x³+a₄x⁴+a₅x⁵+a₆x⁶, the number of monomials in the first polynomial is 6, N is set to 2, and three second polynomials are obtained from the first polynomial, that is, a₁x¹+a₂x², a₃x³+a₄x⁴, and a₅x⁵+a₆x⁶. Each second polynomial includes two variables: a 0^{th} variable and a 1^{st} variable, that is, a value of k is 0 or 1. A second polynomial of a lowest degree is a₁x¹+a₂x².

In this embodiment of the present disclosure, the value of k is 0 or 1. The following uses an example in which the value of k is 0 for description. For a 0^{th} second polynomial a₁x¹+a₂x², a 0^{th} variable in the second polynomial is x¹, and the 0^{th} variable in the second polynomial a₁x¹+a₂x² of the lowest degree is x¹. In this case, a reference variable corresponding to the 0th second polynomial is x¹/x¹=1. A ratio a₁x¹+a₂x² of the 0^{th} second polynomial a₁x¹+a₂x² to the corresponding reference variable 1 is used as a 0^{th} second-degree polynomial.

For a 1^{st} second polynomial a₃x³+a₄x⁴, a 0^{th} variable in the second polynomial is x³, and the 0^{th} variable in the second polynomial a₁x¹+a₂x² of the lowest degree is x¹. In this case, a reference variable corresponding to the 1^{st} second polynomial is x³/x¹=x². A ratio a₃x¹+a₄x² of the 1^{st} second polynomial a₃x³+a₄x⁴ to the corresponding reference variable x² is used as a 1^{st} second-degree polynomial.

For a 2^{nd} second polynomial a₅x⁵+a₆x⁶, a 0^{th} variable in the second polynomial is x⁵, and the 0^{th} variable in the second polynomial a₁x¹+a₂x² of the lowest degree is x¹. In this case, a reference variable corresponding to the 2^{nd} second polynomial is x⁵/x¹=x⁴. A ratio a₅x¹+a₆x² of the 2^{nd} second polynomial a₅x⁵+a₆x⁶ to the corresponding reference variable x⁴ is used as a 2^{nd} second-degree polynomial.

In conclusion, the three second-degree polynomials extracted from the first polynomial a₁x¹+a₂x²+a₃x³+a₄x⁴+a₅x⁵+a₆x⁶ are a₁x¹+a₂x², a₃x¹+a₄x², and a₅x¹+a₆x², and the three reference variables corresponding to the three second-degree polynomials are 1, x², and x⁴. Therefore, the first polynomial a₁x¹+a₂x²+a₃x³+a₄x⁴+a₅x⁵+a₆x⁶ may be decomposed into the following structure:

$$\begin{matrix}{a}_{1} {x}^{1} + {a}_{2} {x}^{2} + {a}_{3} {x}^{3} + {a}_{4} {x}^{4} + {a}_{5} {x}^{5} + {a}_{6} {x}^{6} \\ = 1 * ( {a}_{1} {x}^{1} + {a}_{2} {x}^{2} ) + {x}^{2} * ( {a}_{3} {x}^{1} + {a}_{4} {x}^{2} ) + {x}^{4} * ( {a}_{5} {x}^{1} + {a}_{6} {x}^{2} )\end{matrix}$$

In this embodiment of the present disclosure, each N^{th}-degree polynomial includes N common variables and N variable coefficients, the N common variables are in one-to-one correspondence with the N variable coefficients, and the N common variables included in each of the M N^{th}-degree polynomials are the same as those included in another one in the M N^{th}-degree polynomials.

Based on the foregoing example, each second-degree polynomial includes two common variables x¹ and x². The 0^{th} second-degree polynomial includes two common variables x¹ and x², and variable coefficients corresponding to the two common variables are a₁ and a₂. The 1^{st} second-degree polynomial includes two common variables x¹ and x², and variable coefficients corresponding to the two common variables are a₃ and a₄. The 2^{nd} second-degree polynomial includes common variables x¹ and x², and variable coefficients corresponding to the two common variables are a₅ and a₆.

S204: Load the respective common variable corresponding to each of the at least one to-be-calculated polynomial to at least one first register group, load the respective variable coefficient corresponding to each of the at least one to-be-calculated polynomial to at least one second register group, and load the respective reference variable corresponding to each of the at least one to-be-calculated polynomial to at least one third register group.

For the first polynomial in the at least one to-be-calculated polynomial, the following steps are performed: loading the N common variables corresponding to the first polynomial to a first destination register group, where the first destination register group is any one of the at least one first register group; loading the M*N variable coefficients corresponding to the first polynomial to a second destination register group, where the second destination register group is any one of the at least one second register group; and loading the M reference variables corresponding to the first polynomial to a third destination register group, where the third destination register group is any one of the at least one third register group.

In this embodiment of the present disclosure, the first register group includes a plurality of first registers, and each first register includes a plurality of storage locations. Generally, the first register group includes eight first registers. Each first register may store 512-bit (binary digit, bit) data. It is set that each first register includes eight storage locations. Therefore, each storage location in the first register may store 64-bit data. The first register may be a scalable vector extension (SVE) register.

As shown in FIG. 4, for ease of description in the following, each first register in the first register group may be numbered, and the eight first registers are respectively numbered V0, V1, V2, V3, V4, V5, V6, and V7. Each storage location in each first register may be further numbered, and the eight storage locations in each first register are respectively numbered 0, 1, 2, 3, 4, 5, 6, and 7. Each storage location in the first register group may be initialized to 0.

In a possible implementation, loading the N common variables corresponding to the first polynomial to the first destination register group may be implemented by using the following step: loading an i^{th} common variable in the N common variables to a j^{th} storage location in a (b+i)^{th} first register in the first destination register group, where i is an integer in [0, N−1], j is a nonnegative integer, and b is a nonnegative integer. In this embodiment of the present disclosure, because the first register group includes the eight first registers, and each first register includes eight storage locations, a value of (b+i) is any integer in a range of [0, 7], and a value of j is any integer in the range of [0, 7].

In this embodiment of the present disclosure, a loading manner of the N common variables corresponding to the first polynomial may include the following manners.

For a 0^{th} common variable corresponding to the first polynomial, the 0^{th} common variable may be loaded in the following manner. For example, the 0^{th} common variable is directly obtained from the N common variables, and the 0^{th} common variable is loaded to the first destination register group.

For another common variable corresponding to the first polynomial other than the 0^{th} common variable, the another common variable may be loaded in the following two possible manners. In one possible manner, the another common variable is directly obtained from the N common variables, and the another common variable is loaded to the first destination register group. In the other possible manner, calculation is performed based on the 0^{th} common variable in the first destination register group, to obtain the another common variable. For example, if the 0^{th} common variable is x¹, and the another common variable is x², after x¹ is loaded to the first destination register group, calculation is performed in the first destination register group, x¹*x¹ is used as the common variable x², and x² obtained is added to the first destination register group.

For example, the first polynomial is a₁x¹+a₂x²+a₃x³+a₄x⁴+a₅x⁵+a₆x⁶, and three second-degree polynomials corresponding to the first polynomial are a₁x¹+a₂x², a₃x¹+a₄x², and asx1+a₆x². Three reference variables corresponding to the three second-degree polynomials are 1, x², and x⁴.

The three second-degree polynomials each include two common variables x¹ and x², where a 0^{th} common variable is x¹, and a 1^{st} common variable is x². It is set that j=0 and b=0. As shown in FIG. 5, the 0^{th} common variable x¹ is loaded to a 0^{th} storage location in a 0^{th} (0+0=0) first register in the first destination register group, and the 1^{st} common variable x² is loaded to a 0^{th} storage location in a 1^{st} (0+1=1) first register in the first destination register group. The 0^{th} first register is a first register V0, and the 1^{st} first register is a first register V1.

It should be understood that common variables in storage locations in the (b+i)^{th} first register in the first destination register group should correspond to a same variable coefficient. When common variables correspond to a same variable coefficient, the common variables corresponding to the same variable coefficient may be loaded to different storage locations in a same first register. For example, the common variable x¹ is stored in the 0^{th} storage location in the 0^{th} first register in the first destination register group, and a corresponding variable coefficient is a₁. A common variable y¹ is stored in a 1^{st} storage location in the 0^{th} first register in the first destination register group, and a corresponding variable coefficient is still a₁. The common variables x¹ and y¹ correspond to the same variable coefficient.

In this embodiment of the present disclosure, the second register group includes a plurality of second registers, and each second register includes a plurality of storage locations. Generally, the second register group includes eight second registers. Each second register may store 512-bit data. It is set that each second register includes eight storage locations. Therefore, each storage location in the second register may store 64-bit data. The second register may be a scalable matrix extension (SME) register.

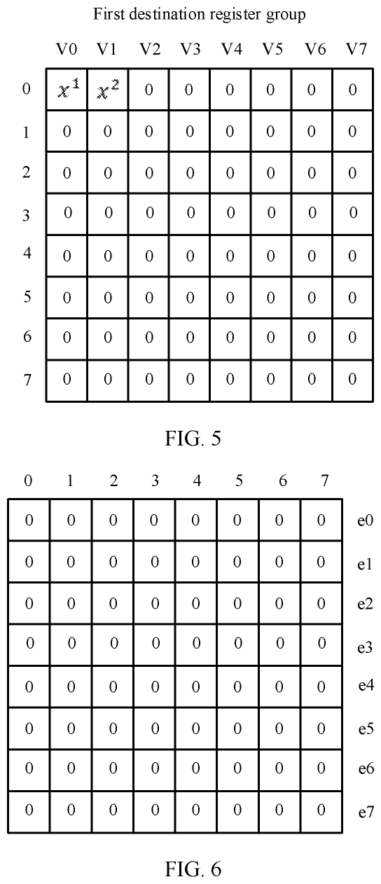

As shown in FIG. 6, for ease of description below, each second register in the second register group may be numbered, and the eight second registers are respectively numbered e0, e1, e2, e3, e4, e5, e6, and e7. Each storage location in each second register may be further numbered, and the eight storage locations in each second register are respectively numbered 0, 1, 2, 3, 4, 5, 6, and 7. Each storage location in the second register group may be initialized to 0. For ease of understanding polynomial calculation more intuitively in the following, the second registers in the second register group use a structure shown in FIG. 6. The second registers in the second register group may alternatively be arranged in another manner. This is not limited herein.

In a possible implementation, loading the M*N variable coefficients corresponding to the first polynomial to the second destination register group may be implemented by using the following step: loading an it^{h} variable coefficient corresponding to an m^{th} N^{th}-degree polynomial in the M N^{th}-degree polynomials to a (b+m)^{th} storage location in a (b+i)^{th} second register in the second destination register group, where m is an integer in [0, M−1], i is an integer in [0, N−1], and b is a nonnegative integer. In this embodiment of the present disclosure, because the second register group includes eight second registers, and each second register includes eight storage locations, a value of (b+i) is any integer in the range of [0, 7], and a value of (b+m) is any integer in the range of [0, 7].

For example, the first polynomial is a₁x¹+a₂x²+a₃x³+a₄x⁴+a₅x⁵+a₆x⁶, and three second-degree polynomials corresponding to the first polynomial are a₁x¹+a₂x², a₃x¹+a₄x², and asx1+a₆x². Variable coefficients corresponding to the three second-degree polynomials are a₁, a₂, a₃, a₄, a₅, and a₆.

It is set that b=0. As shown in FIG. 7, variable coefficients corresponding to a 0^{th} second-degree polynomial a₁x¹+a₂x² are a₁ and a₂. In the 0^{th} second-degree polynomial, a 0^{th} variable coefficient is a₁, and a 1^{st} variable coefficient is a₂. When m=0 and i=0, the 0^{th} variable coefficient a₁ in the 0^{th} second-degree polynomial is loaded to a 0^{th} (0+0=0) storage location in a 0^{th} (0+0=0) second register in the second destination register group. When m=0 and i=1, the 1^{st} variable coefficient a₂ in the 0^{th} second-degree polynomial is loaded to a 0^{th} (0+0=0) storage location in a 1^{st} (0+1=1) second register in the second destination register group. The 0^{th} second register is the second register e0, and the 1^{st} second register is the second register e1.

Variable coefficients corresponding to a 1^{st} second-degree polynomial a₃x¹+a₄x² are a₃ and a₄. In the 1^{st} second-degree polynomial, a 0^{th} variable coefficient is a₃, and a 1^{st} variable coefficient is a₄. When m=1 and i=0, the 0^{th} variable coefficient a₃ in the 1^{st} second-degree polynomial is loaded to a 1^{st} (0+1=1) storage location in the 0^{th} (0+0=0) second register in the second destination register group. When m=1 and i=1, the 1^{st} variable coefficient a₄ in the 1^{st} second-degree polynomial is loaded to a 1^{st} (0+1=1) storage location in the 1^{st} (0+1=0) second register in the second destination register group. The 0^{th} second register is the second register e0, and the 1^{st} second register is the second register e1.

Variable coefficients corresponding to a 2^{nd} second-degree polynomial asx1+a₆x² are a₅ and a₆. In the 2^{nd} second-degree polynomial, a 0^{th} variable coefficient is as, and a 1^{st} variable coefficient is a₆. When m=2 and i=0, the 0^{th} variable coefficient as in the 2^{nd} second-degree polynomial is loaded to a 2^{nd} (0+2=2) storage location in the 0^{th} (0+0=0) second register in the second destination register group. When m=2 and i=1, the 1^{st} variable coefficient a₆ in the 2^{nd} second-degree polynomial is loaded to a 2^{nd} (0+2=2) storage location in the 1^{st} (0+1=0) second register in the second destination register group. The 0^{th} second register is the second register e0, and the 1^{st} second register is the second register e1.

In this embodiment of the present disclosure, the third register group includes a plurality of third registers, and each third register includes a plurality of storage locations. Generally, the third register group includes eight third registers. Each third register may store 512-bit data. It is set that each third register includes eight storage locations. Therefore, each storage location in the third register may store 64-bit data. The third register may be an SVE register.

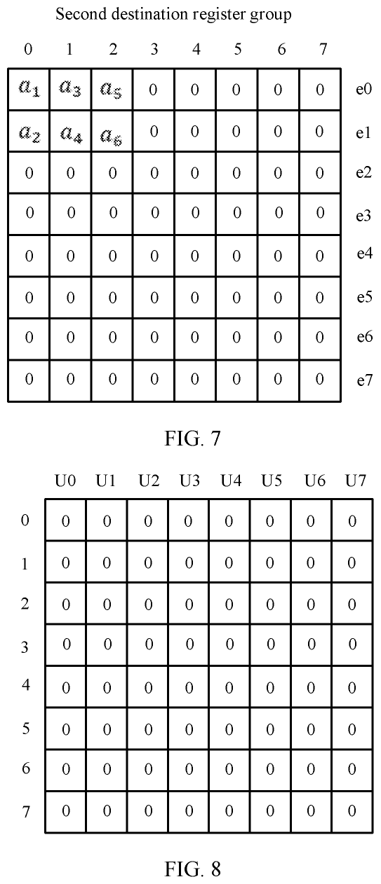

As shown in FIG. 8, for ease of description in the following, each third register in the third register group may be numbered, and the eight third registers are respectively numbered U0, U1, U2, U3, U4, U5, U6, and U7. Each storage location in each third register may be further numbered, and the eight storage locations in each third register are respectively numbered 0, 1, 2, 3, 4, 5, 6, and 7. Each storage location in the third register group may be initialized to 0.

In a possible implementation, loading the M reference variables corresponding to the first polynomial to the third destination register group may be implemented by using the following step: loading an m^{th} reference variable in the M reference variables to a j^{th} storage location in a (b+m)^{th} third register in the third destination register group, where m is an integer in [0, M−1], b is a nonnegative integer, and j is a nonnegative integer. In this embodiment of the present disclosure, because the third register group includes eight third registers, and each third register includes eight storage locations, a value of (b+m) is any integer in the range of [0, 7], and a value of j is any integer in the range of [0, 7].

For example, the first polynomial is a₁x¹+a₂x²+a₃x³+a₄x⁴+a₅x⁵+a₆x⁶, and three second-degree polynomials corresponding to the first polynomial are a₁x¹+a₂x², a₃x¹+a₄x², and a₅x¹+a₆x². Three reference variables corresponding to the three second-degree polynomials are 1, x², and x⁴.

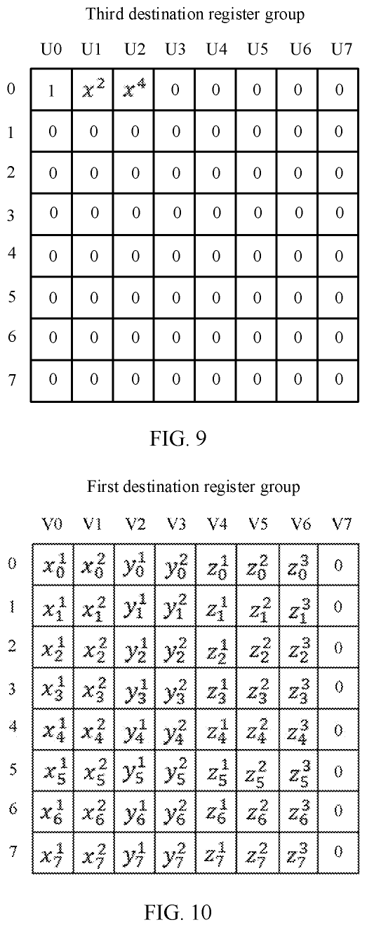

It is set that j=0 and b=0. As shown in FIG. 9, when m=0, a 0^{th} reference variable 1 is loaded to a 0^{th} storage location in a 0^{th} (0+0=0) third register in the third destination register group. The 0^{th} third register is the third register U0.

When m=1, a 1^{st} reference variable x² is loaded to a 0^{th} storage location in a 1^{st} (0+1=1) third register in the third destination register group. The 1^{st} third register is the third register U1.

When m=2, a 2^{nd} reference variable x⁴ is loaded to a 0^{th} storage location in a 2^{nd}(0+2=2) third register in the third destination register group. The 2^{nd} third register is the third register U2.

When a plurality of first polynomials are obtained, the foregoing manner may be used to determine N common variables, M*N variable coefficients, and M reference variables corresponding to each first polynomial, load the N common variables corresponding to each first polynomial to the first destination register group, load the M*N variable coefficients corresponding to each first polynomial to the second destination register group, and load the M reference variables corresponding to each first polynomial to the third destination register group.

24 first polynomials are used as an example for description, where a 0^{th} first polynomial to a 7^{th} first polynomial are:

$$\begin{matrix}{a}_{1} {x}_{0}^{1} + {a}_{2} {x}_{0}^{2} + {a}_{3} {x}_{0}^{3} + {a}_{4} {x}_{0}^{4} + {a}_{5} {x}_{0}^{5} + {a}_{6} {x}_{0}^{6} \\ {a}_{1} {x}_{1}^{1} + {a}_{2} {x}_{1}^{2} + {a}_{3} {x}_{1}^{3} + {a}_{4} {x}_{1}^{4} + {a}_{5} {x}_{1}^{5} + {a}_{6} {x}_{1}^{6} \\ {a}_{1} {x}_{2}^{1} + {a}_{2} {x}_{2}^{2} + {a}_{3} {x}_{2}^{3} + {a}_{4} {x}_{2}^{4} + {a}_{5} {x}_{2}^{5} + {a}_{6} {x}_{2}^{6} \\ {a}_{1} {x}_{3}^{1} + {a}_{2} {x}_{3}^{2} + {a}_{3} {x}_{3}^{3} + {a}_{4} {x}_{3}^{4} + {a}_{5} {x}_{3}^{5} + {a}_{6} {x}_{3}^{6} \\ {a}_{1} {x}_{4}^{1} + {a}_{2} {x}_{4}^{2} + {a}_{3} {x}_{4}^{3} + {a}_{4} {x}_{4}^{4} + {a}_{5} {x}_{4}^{5} + {a}_{6} {x}_{4}^{6} \\ {a}_{1} {x}_{5}^{1} + {a}_{2} {x}_{5}^{2} + {a}_{3} {x}_{5}^{3} + {a}_{4} {x}_{5}^{4} + {a}_{5} {x}_{5}^{5} + {a}_{6} {x}_{5}^{6} \\ {a}_{1} {x}_{6}^{1} + {a}_{2} {x}_{6}^{2} + {a}_{3} {x}_{6}^{3} + {a}_{4} {x}_{6}^{4} + {a}_{5} {x}_{6}^{5} + {a}_{6} {x}_{6}^{6} \\ {a}_{1} {x}_{7}^{1} + {a}_{2} {x}_{7}^{2} + {a}_{3} {x}_{7}^{3} + {a}_{4} {x}_{7}^{4} + {a}_{5} {x}_{7}^{5} + {a}_{6} {x}_{7}^{6}\end{matrix}$$

x₀, x₁, x₂, x₃, x₄, x₅, x₆, and x₇ are basic variables with different values.

The 0^{th} first polynomial is used as an example for description. The 0^{th} first polynomial may be represented in the following manner:

$$\begin{matrix}{a}_{1} {x}_{0}^{1} + {a}_{2} {x}_{0}^{2} + {a}_{3} {x}_{0}^{3} + {a}_{4} {x}_{0}^{4} + {a}_{5} {x}_{0}^{5} + {a}_{6} {x}_{0}^{6} \\ = 1 * ( {a}_{1} {x}_{0}^{1} + {a}_{2} {x}_{0}^{2} ) + {x}_{0}^{2} * ( {a}_{3} {x}_{0}^{1} + {a}_{4} {x}_{0}^{2} ) + {x}_{0}^{4} * ( {a}_{5} {x}_{0}^{1} + {a}_{6} {x}_{0}^{2} )\end{matrix}$$

The 0^{th} first polynomial includes three second-degree polynomials. Three reference variables corresponding to the three second-degree polynomials are 1,

$${x}_{0}^{2} and {x}_{0}^{4} .$$

Common variables included in each of the three second-degree polynomials are

$${x}_{0}^{1} and {x}_{0}^{2} .$$

Variable coefficients included in the three second-degree polynomials are a₁, a₂, a₃, a₄, a₅, and a₆.

A method for obtaining reference variables, common variables, and variable coefficients of the 1^{st} to the 7^{th} first polynomials is similar to a method for obtaining the reference variables, the common variables, and the variable coefficients of the 0^{th} first polynomial.

An 8^{th} first polynomial to a 15^{th} first polynomial are:

$$\begin{matrix}{b}_{1} {y}_{0}^{1} + {b}_{2} {y}_{0}^{2} + {b}_{3} {y}_{0}^{3} + {b}_{4} {y}_{0}^{4} \\ {b}_{1} {y}_{1}^{1} + {b}_{2} {y}_{1}^{2} + {b}_{3} {y}_{1}^{3} + {b}_{4} {y}_{1}^{4} \\ {b}_{1} {y}_{2}^{1} + {b}_{2} {y}_{2}^{2} + {b}_{3} {y}_{2}^{3} + {b}_{4} {y}_{2}^{4} \\ {b}_{1} {y}_{3}^{1} + {b}_{2} {y}_{3}^{2} + {b}_{3} {y}_{3}^{3} + {b}_{4} {y}_{3}^{4} \\ {b}_{1} {y}_{4}^{1} + {b}_{2} {y}_{4}^{2} + {b}_{3} {y}_{4}^{3} + {b}_{4} {y}_{4}^{4} \\ {b}_{1} {y}_{5}^{1} + {b}_{2} {y}_{5}^{2} + {b}_{3} {y}_{5}^{3} + {b}_{4} {y}_{5}^{4} \\ {b}_{1} {y}_{6}^{1} + {b}_{2} {y}_{6}^{2} + {b}_{3} {y}_{6}^{3} + {b}_{4} {y}_{6}^{4} \\ {b}_{1} {y}_{7}^{1} + {b}_{2} {y}_{7}^{2} + {b}_{3} {y}_{7}^{3} + {b}_{4} {y}_{7}^{4}\end{matrix}$$

y₀, y₁, y₂, y₃, y₄, y₅, y₆, and y₇ are basic variables with different values.

The 8^{th} first polynomial is used as an example for description. The 8^{th} first polynomial may be represented in the following manner:

$${b}_{1} {y}_{0}^{1} + {b}_{2} {y}_{0}^{2} + {b}_{3} {y}_{0}^{3} + {b}_{4} {y}_{0}^{4} = 1 * ( {b}_{1} {y}_{0}^{1} + {b}_{2} {y}_{0}^{2} ) + {y}_{0}^{2} * ( {b}_{3} {y}_{0}^{1} + {b}_{4} {y}_{0}^{2} )$$

The 8^{th} first polynomial includes two second-degree polynomials. Two reference variables corresponding to the two second-degree polynomials are 1 and

$${y}_{0}^{2} .$$

Common variables included in each of the two second-degree polynomials are

$${y}_{0}^{1} and {y}_{0}^{2} .$$

Variable coefficients included in the two second-degree polynomials are b₁, b₂, b₃, and b₄.

A method for obtaining reference variables, common variables, and variable coefficients of the 9^{th} to the 15^{th} first polynomials is similar to a method for obtaining the reference variables, the common variables, and the variable coefficients of the 8^{th} first polynomial.

A 16^{th} first polynomial to a 23^{rd} first polynomial are:

$$\begin{matrix}{c}_{1} {z}_{0}^{1} + {c}_{2} {z}_{0}^{2} + {c}_{3} {z}_{0}^{3} + {c}_{4} {z}_{0}^{4} + {c}_{5} {z}_{0}^{5} + {c}_{6} {z}_{0}^{6} \\ {c}_{1} {z}_{1}^{1} + {c}_{2} {z}_{1}^{2} + {c}_{3} {z}_{1}^{3} + {c}_{4} {z}_{1}^{4} + {c}_{5} {z}_{1}^{5} + {c}_{6} {z}_{1}^{6} \\ {c}_{1} {z}_{2}^{1} + {c}_{2} {z}_{2}^{2} + {c}_{3} {z}_{2}^{3} + {c}_{4} {z}_{2}^{4} + {c}_{5} {z}_{2}^{5} + {c}_{6} {z}_{2}^{6} \\ {c}_{1} {z}_{3}^{1} + {c}_{2} {z}_{3}^{2} + {c}_{3} {z}_{3}^{3} + {c}_{4} {z}_{3}^{4} + {c}_{5} {z}_{3}^{5} + {c}_{6} {z}_{3}^{6} \\ {c}_{1} {z}_{4}^{1} + {c}_{2} {z}_{4}^{2} + {c}_{3} {z}_{4}^{3} + {c}_{4} {z}_{4}^{4} + {c}_{5} {z}_{4}^{5} + {c}_{6} {z}_{4}^{6} \\ {c}_{1} {z}_{5}^{1} + {c}_{2} {z}_{5}^{2} + {c}_{3} {z}_{5}^{3} + {c}_{4} {z}_{5}^{4} + {c}_{5} {z}_{5}^{5} + {c}_{6} {z}_{5}^{6} \\ {c}_{1} {z}_{6}^{1} + {c}_{2} {z}_{6}^{2} + {c}_{3} {z}_{6}^{3} + {c}_{4} {z}_{6}^{4} + {c}_{5} {z}_{6}^{5} + {c}_{6} {z}_{6}^{6} \\ {c}_{1} {z}_{7}^{1} + {c}_{2} {z}_{7}^{2} + {c}_{3} {z}_{7}^{3} + {c}_{4} {z}_{7}^{4} + {c}_{5} {z}_{7}^{5} + {c}_{6} {z}_{7}^{6}\end{matrix}$$

z₀, z₁, z₂, z₃, z₄, z₅, z₆, and z₇ are basic variables with different values.

The 16^{th} first polynomial is used as an example for description. The 16^{th} first polynomial may be represented in the following manner:

$${c}_{1} {z}_{0}^{1} + {c}_{2} {z}_{0}^{2} + {c}_{3} {z}_{0}^{3} + {c}_{4} {z}_{0}^{4} + {c}_{5} {z}_{0}^{5} + {c}_{6} {z}_{0}^{6} = 1 * ( {c}_{1} {z}_{0}^{1} + {c}_{2} {z}_{0}^{2} + {c}_{3} {z}_{0}^{3} ) + {z}_{0}^{3} * ( {c}_{4} {z}_{0}^{1} + {c}_{5} {z}_{0}^{2} + {c}_{6} {z}_{0}^{3} )$$

The 16^{th} first polynomial includes two third-degree polynomials. Two reference variables corresponding to the two third-degree polynomials are 1 and

$${z}_{0}^{3} .$$

Common variables included in each of the two third-degree polynomials are

$${z}_{0}^{1} , {z}_{0}^{2} , and {z}_{0}^{3} .$$

Variable coefficients included in the two third-degree polynomials are c₁, c₂, c₃, c₄, c₅, and c₆.

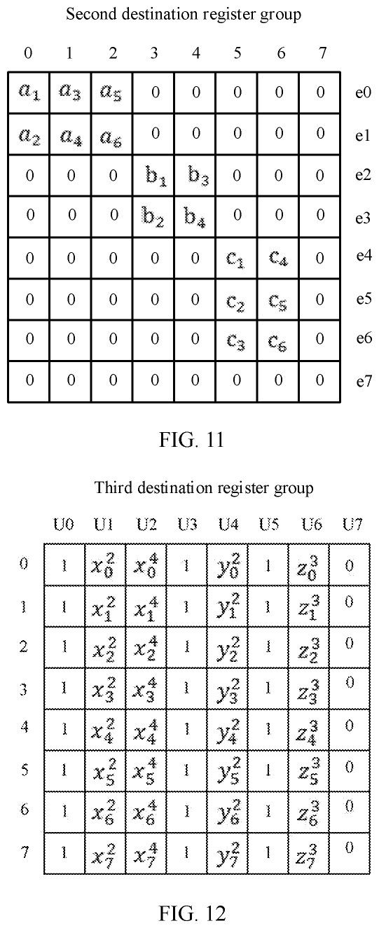

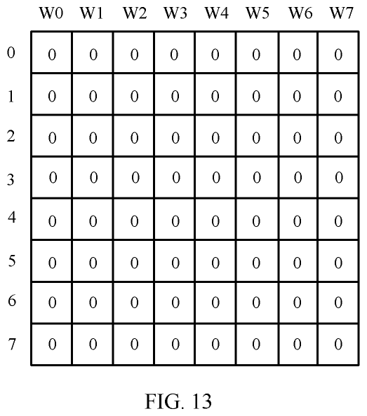

As shown in FIG. 10, the common variables corresponding to the 24 first polynomials are added to the first destination register group. As shown in FIG. 11, the variable coefficients corresponding to the 24 first polynomials are loaded to the second destination register group. As shown in FIG. 12, the reference variables corresponding to the 24 first polynomials are loaded to the third destination register group.

S205: Control outer product calculation to be performed on the common variable in the at least one first register group and the variable coefficient in the at least one second register group, to obtain a first result corresponding to each of the at least one to-be-calculated polynomial.

For the first polynomial in the at least one to-be-calculated polynomial, outer product calculation is controlled to be performed on the common variable in the first destination register group and the variable coefficient in the second destination register group, to obtain a first result corresponding to the first polynomial.

In this embodiment of the present disclosure, the first result corresponding to the first polynomial may be stored in a fourth destination register group. The fourth destination register group includes a plurality of fourth registers, and each fourth register includes a plurality of storage locations. Generally, a fourth register group includes eight fourth registers. Each fourth register may store 512-bit data. It is set that each fourth register includes eight storage locations. Therefore, each storage location in the fourth register may store 64-bit data. The fourth register may be an SVE register.

As shown in FIG. 13, for ease of description in the following, each fourth register in the fourth register group may be numbered, and the eight fourth registers are respectively numbered W0, Wi, W2, W3, W4, W5, W6, and W7. Each storage location in each fourth register may be further numbered, and the eight storage locations in each fourth register are respectively numbered 0, 1, 2, 3, 4, 5, 6, and 7. Each storage location in the fourth register group may be initialized to 0.

Specifically, an m^{th} first result in M first results corresponding to the first polynomial may be loaded to a j^{th} storage location in a (b+m)^{th} fourth destination register, where m is an integer in [0, M−1], b is a nonnegative integer, and j is a nonnegative integer. In this embodiment of the present disclosure, because the fourth register group includes eight fourth registers, and each fourth register includes eight storage locations, a value of (b+m) is any integer in the range of [0, 7], and a value of j is any integer in the range of [0, 7].

In a possible implementation, outer product calculation is performed on a b^{th} storage location in each first register in the first destination register group and a q^{th} storage location in each second register in the second destination register group, to obtain a first result corresponding to the first polynomial, where b is an integer in [0, 7], and q is an integer in [0, 7].

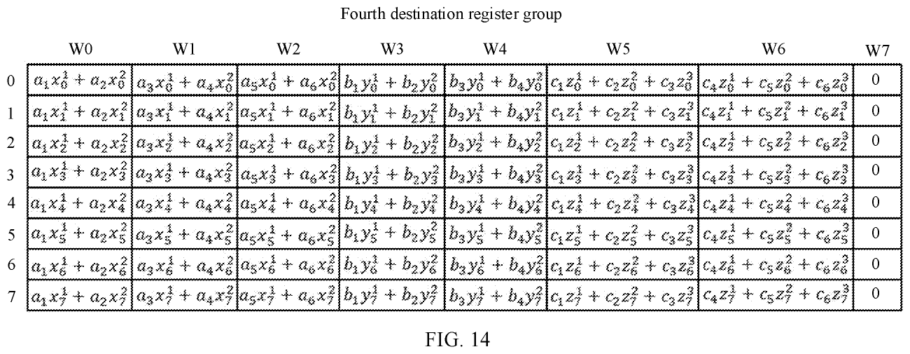

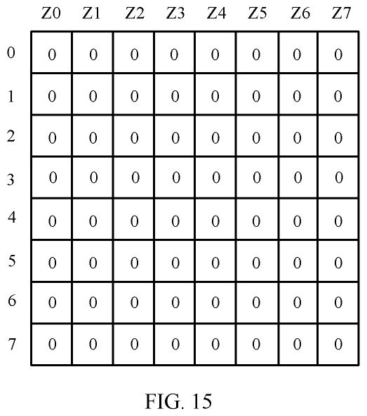

The foregoing 24 first polynomials are used for description. The common variables corresponding to the 24 first polynomials are stored in the first destination register group shown in FIG. 10, and the variable coefficients corresponding to the 24 first polynomials are stored in the second destination register group shown in FIG. 11. How to perform outer product calculation based on the common variables in the first destination register group and the variable coefficients in the second destination register group to obtain first results corresponding to the 24 first polynomials is described. The first results corresponding to the 24 first polynomials are stored in the fourth destination register group shown in FIG. 14.

Outer product calculation is performed on a 0^{th} storage location in each first register in the first destination register group and a 0^{th} storage location in each second register in the second destination register group, to obtain a first result

$${a}_{1} {x}_{0}^{1} + {a}_{2} {x}_{0}^{2} ,$$

and the first result

$${a}_{1} {x}_{0}^{1} + {a}_{2} {x}_{0}^{2}$$

is loaded to a 0^{th} storage location in the 0^{th} fourth destination register.

Outer product calculation is performed on the 0^{th} storage location in each first register in the first destination register group and a 1^{st} storage location in each second register in the second destination register group to obtain a first result

$${a}_{3} {x}_{0}^{1} + {a}_{4} {x}_{0}^{2} ,$$

and the first result

$${a}_{3} {x}_{0}^{1} + {a}_{4} {x}_{0}^{2}$$

is loaded to a 0^{th} storage location in the 1^{st} fourth destination register.

Outer product calculation is performed on the 0^{th} storage location in each first register in the first destination register group and a 2^{nd} storage location in each second register in the second destination register group, to obtain a first result

$${a}_{5} {x}_{0}^{1} + {a}_{6} {x}_{0}^{2} ,$$

and the first result

$${a}_{5} {x}_{0}^{1} + {a}_{6} {x}_{0}^{2}$$

is loaded to a 0^{th} storage location in the 2^{nd} fourth destination register.

Outer product calculation is performed on the 0^{th} storage location in each first register in the first destination register group and a 3^{rd} storage location in each second register in the second destination register group, to obtain a first result

$${b}_{1} {y}_{0}^{1} + {b}_{2} {y}_{0}^{2} ,$$

and the first result

$${b}_{1} {y}_{0}^{1} + {b}_{2} {y}_{0}^{2}$$

is loaded to a 0^{th} storage location in the 3^{rd} fourth destination register.

Outer product calculation is performed on the 0^{th} storage location in each first register in the first destination register group and a 4^{th} storage location in each second register in the second destination register group, to obtain a first result

$${b}_{3} {y}_{0}^{1} + {b}_{4} {y}_{0}^{2} ,$$

and the first result

$${b}_{3} {y}_{0}^{1} + {b}_{4} {y}_{0}^{2}$$

is loaded to a 0^{th} storage location in the 4^{th} fourth destination register.

Outer product calculation is performed on the 0^{th} storage location in each first register in the first destination register group and a 5^{th} storage location in each second register in the second destination register group, to obtain a first result

$${c}_{1} {z}_{0}^{1} + {c}_{2} {z}_{0}^{2} + {c}_{3} {z}_{0}^{3} ,$$

and the first result

$${c}_{1} {z}_{0}^{1} + {c}_{2} {z}_{0}^{2} + {c}_{3} {z}_{0}^{3}$$

is loaded to a 0^{th} storage location in the 5^{th} fourth destination register.

Outer product calculation is performed on the 0^{th} storage location in each first register in the first destination register group and a 6^{th} storage location in each second register in the second destination register group, to obtain a first result

$${c}_{4} {z}_{0}^{1} + {c}_{5} {z}_{0}^{2} + {c}_{6} {z}_{0}^{3} ,$$

and the first result

$${c}_{4} {z}_{0}^{1} + {c}_{5} {z}_{0}^{2} + {c}_{6} {z}_{0}^{3}$$

is loaded to a 0^{th} storage location in the 6^{th} fourth destination register.

Outer product calculation is performed on the 0^{th} storage location in each first register in the first destination register group and a 7^{th} storage location in each second register in the second destination register group, to obtain a first result 0, and the first result 0 is loaded to a 0^{th} storage location in the 7^{th} fourth destination register.

The foregoing steps are repeated for a 1^{st} to a 7^{th} storage locations in each first register in the first destination register group.

S206: Control inner product calculation to be performed on the first result corresponding to each of the at least one to-be-calculated polynomial and the reference variable in the at least one third register group, to obtain a second result corresponding to each of the at least one to-be-calculated polynomial.

For the first polynomial in the at least one to-be-calculated polynomial, inner product calculation is controlled to be performed on the first result corresponding to the first polynomial and the reference variable in the third destination register group, to obtain a second result corresponding to the first polynomial.

In this embodiment of the present disclosure, the second result of the first polynomial may be stored in a fifth destination register group. The fifth destination register group includes a plurality of fifth registers, and each fifth register includes a plurality of storage locations. Generally, a fifth register group includes eight fifth registers. Each fifth register may store 512-bit data. It is set that each fifth register includes eight storage locations. Therefore, each storage location in the fifth register may store 64-bit data. The fifth register may be an SVE register.

As shown in FIG. 15, for ease of description in the following, each fifth register in the fifth register group may be numbered, and the eight fifth registers are respectively numbered Z0, Z1, Z2, Z3, Z4, Z5, Z6, and Z7. Each storage location in each fifth register may be further numbered, and the eight storage locations in each fifth register are respectively numbered 0, 1, 2, 3, 4, 5, 6, and 7. Each storage location in the fifth register group may be initialized to 0.

It should be understood that before inner product calculation is performed, a number of first results corresponding to the first polynomial and a number of reference variables need to be determined. In this embodiment of the present disclosure, the number of first results corresponding to the first polynomial is M, and the number of reference variables is M. The number of first results corresponding to the first polynomial and the number of reference variables may be stored in a sixth destination register group before inner product calculation.

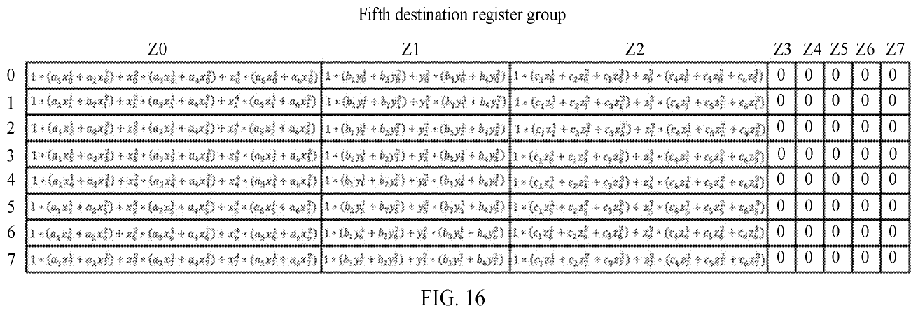

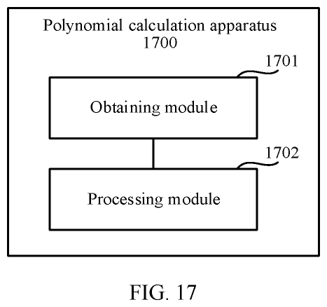

The third destination register group shown in FIG. 12 and the fourth destination register group shown in FIG. 14 are used as an example to describe how to perform inner product calculation on the first results in the fourth destination register group and the reference variables in the third destination register group, to obtain second results of the 24 first polynomials. The second results of the 24 first polynomials are stored in the fifth destination register group shown in FIG. 16.

It is determined that a number of first temporary values corresponding to the 0^{th} first polynomial is 3, and a number of reference variables is 3. Inner product calculation is performed on 0^{th} storage locations in fourth registers W0 to W2 in the fourth destination register group and 0^{th} storage locations in third registers U0 to U2 in the third destination register group, to obtain a second result

$$1 * ( {a}_{1} {x}_{0}^{1} + {a}_{2} {x}_{0}^{2} ) + {x}^{2} * ( {a}_{3} {x}_{0}^{1} + {a}_{4} {x}_{0}^{2} ) + {x}^{4} * ( {a}_{5} {x}_{0}^{1} + {a}_{6} {x}_{0}^{2} )$$

of the first polynomial, and the second result

$$1 * ( {a}_{1} {x}_{0}^{1} + {a}_{2} {x}_{0}^{2} ) + {x}^{2} * ( {a}_{3} {x}_{0}^{1} + {a}_{4} {x}_{0}^{2} ) + {x}^{4} * ( {a}_{5} {x}_{0}^{1} + {a}_{6} {x}_{0}^{2} )$$

of the first polynomial is loaded to a 0^{th} storage location in a 0^{th} fifth register in the fifth destination register group.

A process of calculating second results corresponding to the 1^{st} to the 7^{th} first polynomials is similar to a process of calculating the second result of the 0^{th} first polynomial, and details are not described herein.

It is determined that a number of first temporary values corresponding to the 8^{th} first polynomial is 2, and a number of reference variables is 2. Inner product calculation is performed on 0^{th} storage locations in fourth registers W3 and W4 in the fourth destination register group and 0^{th} storage locations in third registers U3 and U4 in the third destination register group, to obtain a second result

$$1 * ( {b}_{1} {y}_{0}^{1} + {b}_{2} {y}_{0}^{2} ) + {y}_{0}^{2} * ( {b}_{3} {y}_{0}^{1} + {b}_{4} {y}_{0}^{2} )$$

of the first polynomial, and the second result

$$1 * ( {b}_{1} {y}_{0}^{1} + {b}_{2} {y}_{0}^{2} ) + {y}_{0}^{2} * ( {b}_{3} {y}_{0}^{1} + {b}_{4} {y}_{0}^{2} )$$

of the first polynomial is loaded to a 0^{th} storage location in a 1^{st} fifth destination register in the fifth destination register group.

A process of calculating second results corresponding to the 9^{th} to the 15^{th} first polynomials is similar to a process of calculating the second result of the 8^{th} first polynomial, and details are not described herein.

It is determined that a number of first temporary values corresponding to the 16^{th} first polynomial is 2, and a number of reference variables is 2. Inner product calculation is performed on 0^{th} storage locations in fourth registers W5 and W6 in the fourth destination register group and 0^{th} storage locations in third registers U5 and U6 in the third destination register group, to obtain a second result

$$1 * ( {c}_{1} {z}_{0}^{1} + {c}_{2} {z}_{0}^{2} + {c}_{3} {z}_{0}^{3} ) + {z}_{0}^{3} * ( {c}_{4} {z}_{0}^{1} + {c}_{5} {z}_{0}^{2} + {c}_{6} {z}_{0}^{3} )$$

of the first polynomial, and the second result

$$1 * ( {c}_{1} {z}_{0}^{1} + {c}_{2} {z}_{0}^{2} + {c}_{3} {z}_{0}^{3} ) + {z}_{0}^{3} * ( {c}_{4} {z}_{0}^{1} + {c}_{5} {z}_{0}^{2} + {c}_{6} {z}_{0}^{3} )$$

of the first polynomial is loaded to a 0^{th} storage location in a 2^{nd} fifth register in the fifth destination register group.

A process of calculating second results corresponding to the 17^{th} to the 23^{rd} first polynomials is similar to a process of calculating the second result of the 16^{th} first polynomial, and details are not described herein.

When a large number of polynomials are calculated, according to the foregoing method, polynomial cyclic calculation may be converted into matrix calculation between register groups, improving a calculation speed.

Based on a same concept as the method embodiment, an embodiment of the present disclosure further provides a polynomial calculation apparatus. The apparatus is configured to perform the method in the method embodiment in FIG. 2. As shown in FIG. 17, the polynomial calculation apparatus 1700 includes an obtaining module 1701 and a processing module 1702. Specifically, in the polynomial calculation apparatus 1700, a connection is established between the modules through a communication path. In an application scenario, the storage 102 stores executable program code, and the processor 101 executes the executable program code to separately implement functions of the obtaining module 1701 and the processing module 1702, to implement the polynomial calculation method provided in this embodiment.

The obtaining module 1701 is configured to obtain a plurality of to-be-calculated polynomials in a polynomial calculation application.

The processing module 1702 is configured to: divide the plurality of to-be-calculated polynomials to obtain a plurality of to-be-calculated groups, where each to-be-calculated group includes at least one to-be-calculated polynomial, the at least one to-be-calculated polynomial in each to-be-calculated group is of a same type, the plurality of to-be-calculated groups include a first to-be-calculated group, and the first to-be-calculated group is any to-be-calculated group in the plurality of to-be-calculated groups; determine a respective common variable, a respective variable coefficient, and a respective reference variable that correspond to each of at least one to-be-calculated polynomial in the first to-be-calculated group, where the at least one to-be-calculated polynomial in the first to-be-calculated group corresponds to a same variable coefficient; load the respective common variable corresponding to each of the at least one to-be-calculated polynomial to at least one first register group, load the respective variable coefficient corresponding to each of the at least one to-be-calculated polynomial to at least one second register group, and load the respective reference variable corresponding to each of the at least one to-be-calculated polynomial to at least one third register group; control outer product calculation to be performed on the common variable in the at least one first register group and the variable coefficient in the at least one second register group, to obtain a first result corresponding to each of the at least one to-be-calculated polynomial; and control inner product calculation to be performed on the first result corresponding to each of the at least one to-be-calculated polynomial and the reference variable in the at least one third register group, to obtain a second result corresponding to each of the at least one to-be-calculated polynomial.

In a possible implementation, that the processing module 1702 determines the common variable, the variable coefficient, and the reference variable that correspond to the at least one to-be-calculated polynomial in the first to-be-calculated group may include: performing the following steps for a first polynomial in the at least one to-be-calculated polynomial, where the first polynomial is any polynomial in the at least one to-be-calculated polynomial: extracting, from the first polynomial, M N^{th}-degree polynomials and M reference variables corresponding to the M N^{th}-degree polynomials, where the M N^{th}-degree polynomials are in one-to-one correspondence with the M reference variables, each N^{th}-degree polynomial includes N common variables and N variable coefficients, the N common variables are in one-to-one correspondence with the N variable coefficients, the N common variables included in each of the M N^{th}-degree polynomials are the same as those included in another one in the M N^{th}-degree polynomials, M is a positive integer, and N is an integer greater than 1; and determining the N common variables and M*N variable coefficients based on the M N^{th}-degree polynomials.

In a possible implementation, before extracting, from the first polynomial, the M N^{th}-degree polynomials and the M reference variables corresponding to the M N^{th}-degree polynomials, the processing module 1702 is further configured to: when it is determined that degrees of monomials included in the first polynomial are non-consecutive, supplement the first polynomial with a monomial corresponding to a missing degree, where a variable coefficient of the monomial corresponding to the missing degree is zero.

In a possible implementation, before extracting, from the first polynomial, the M N^{th}-degree polynomials and the M reference variables corresponding to the M N^{th}-degree polynomials, the processing module 1702 is further configured to: when it is determined that a number of monomials included in the first polynomial is odd, supplement the first polynomial with an odd number of monomials, where variable coefficients of the odd number of monomials are all zero.

In a possible implementation, when extracting, from the first polynomial, the M N^{th}-degree polynomials and the M reference variables corresponding to the M N^{th}-degree polynomials, the processing module 1702 is specifically configured to: use every N monomials of adjacent degrees in the first polynomial as one second polynomial, to obtain M second polynomials; determine respective ratios of a k^{th} variable included in each of the M second polynomials to a k^{th} variable included in a second polynomial of a lowest degree, as M reference variables corresponding to the M second polynomials, where k is a nonnegative integer less than N; and determine ratios of each of the M second polynomials to the corresponding reference variables as the M N^{th}-degree polynomials.

In a possible implementation, that the processing module 1702 loads the respective common variable corresponding to each of the at least one to-be-calculated polynomial to the at least one first register group, loads the respective variable coefficient corresponding to each of the at least one to-be-calculated polynomial to the at least one second register group, and loads the respective reference variable corresponding to each of the at least one to-be-calculated polynomial to the at least one third register group may include: performing the following steps for the first polynomial in the at least one to-be-calculated polynomial, where the first polynomial is any polynomial in the at least one to-be-calculated polynomial: loading the N common variables corresponding to the first polynomial to a first destination register group, where the first destination register group is any one of the at least one first register group; loading the M*N variable coefficients corresponding to the first polynomial to a second destination register group, where the second destination register group is any one of the at least one second register group; and loading the M reference variables corresponding to the first polynomial to a third destination register group, where the third destination register group is any one of the at least one third register group.

In a possible implementation, the first destination register group includes a plurality of first registers, and each first register includes a plurality of storage locations. When loading the N common variables corresponding to the first polynomial to the first destination register group, the processing module 1702 is specifically configured to load an i^{th} common variable in the N common variables to a j^{th} storage location in a (b+i)^{th} first register in the first destination register group, where i is an integer in [0, N−1], j is a nonnegative integer, and b is a nonnegative integer.

In a possible implementation, the second destination register group includes a plurality of second registers, and each second register includes a plurality of storage locations. When loading the M*N variable coefficients corresponding to the first polynomial to the second destination register group, the processing module 1702 is specifically configured to load an i^{th} variable coefficient corresponding to an m^{th} N^{th}-degree polynomial in the M N^{th}-degree polynomials to a (b+m)^{th} storage location in a (b+i)^{th} second register in the second destination register group, where m is an integer in [0, M−1], i is an integer in [0, N−1], and b is a nonnegative integer.

In a possible implementation, the third destination register group includes a plurality of third registers, and each third register includes a plurality of storage locations. When loading the M reference variables corresponding to the first polynomial to the third destination register group, the processing module 1702 is specifically configured to load an m^{th} reference variable in the M reference variables to a j^{th} storage location in a (b+m)^{th} third register in the third destination register group, where m is an integer in [0, M−1], b is a nonnegative integer, and j is a nonnegative integer.

In a possible implementation, when controlling outer product calculation to be performed on the common variable in the at least one first register group and the variable coefficient in the at least one second register group, to obtain the first result corresponding to each of the at least one to-be-calculated polynomial, the processing module 1702 is specifically configured to perform the following step for the first polynomial in the at least one to-be-calculated polynomial, where the first polynomial is any polynomial in the at least one to-be-calculated polynomial: controlling outer product calculation to be performed on the common variable in the first destination register group and the variable coefficient in the second destination register group, to obtain a first result corresponding to the first polynomial.

In a possible implementation, when controlling inner product calculation to be performed on the first result corresponding to each of the at least one to-be-calculated polynomial and the reference variable in the at least one third register group, to obtain the second result corresponding to each of the at least one to-be-calculated polynomial, the processing module 1702 is specifically configured to perform the following step for the first polynomial in the at least one to-be-calculated polynomial, where the first polynomial is any polynomial in the at least one to-be-calculated polynomial: controlling inner product calculation to be performed on the first result corresponding to the first polynomial and the reference variable in the third destination register group, to obtain a second result corresponding to the first polynomial.

An embodiment of the present disclosure further provides a computer program product including instructions. The computer program product may be software or a program product that includes instructions and that can be run on a compute device or stored in any available medium. When the computer program product runs on at least one computer device, the at least one computer device is enabled to perform the method in the embodiment in FIG. 2. Refer to the foregoing related descriptions.

An embodiment of the present disclosure further provide a computer-readable storage medium. The computer-readable storage medium may be any available medium that can be used for storage by a compute device, or a data storage device including one or more available media. The available medium may be a magnetic medium (for example, a floppy disk, a hard disk, or a magnetic tape), an optical medium (for example, a digital versatile disc (DVD)), a semiconductor medium (for example, an SSD), or the like. The computer-readable storage medium includes instructions, and the instructions instruct the compute device to perform the method performed in the embodiment in FIG. 2. Refer to the foregoing related descriptions.

Optionally, the computer-executable instructions in this embodiment of the present disclosure may also be referred to as application code. This is not specifically limited in embodiments of the present disclosure.

A person of ordinary skill in the art may understand that various numbers such as first and second in the present disclosure are merely used for differentiation for ease of description, and are not used to limit the scope of embodiments of the present disclosure or represent a sequence. The term “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “At least one” means one or more. “At least two” means two or more. “At least one”, “any one”, or a similar expression thereof indicates any combination of the items, and includes a singular item (piece) or any combination of plural items (pieces). For example, at least one item (piece or type) of a, b, or c may indicate: a, b, c, a and b, a and c, b and c, or a, b, and c, where a, b, and c may be singular or plural. “A plurality of” means two or more, and another quantifier is similar to this. In addition, an element that appears in singular forms “a”, “an”, and “the” does not mean “one or only one”, but means “one or more”, unless otherwise specified in the context. For example, “a device” means one or more such devices.

All or a part of the foregoing embodiments may be implemented by using software, hardware, firmware, or any combination thereof. When software is used to implement the foregoing embodiments, all or a part of the foregoing embodiments may be implemented in a form of a computer program product. The computer program product includes one or more computer instructions. When the computer program instructions are loaded and executed on a computer, the procedure or functions according to embodiments of the present disclosure are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium that can be accessed by the computer, or a data storage device, such as a server or a data center, integrating one or more available media. The available medium may be a magnetic medium (for example, a floppy disk, a hard disk, or a magnetic tape), an optical medium (for example, a DVD), a semiconductor medium (for example, an SSD), or the like.

The various illustrative logical units and circuits described in embodiments of the present disclosure may implement or operate the described functions by using a general-purpose processor, a digital signal processor, an ASIC, an FPGA, or another programmable logical apparatus, a discrete gate or transistor logic, a discrete hardware component, or a design of any combination thereof. The general-purpose processor may be a microprocessor. Optionally, the general-purpose processor may alternatively be any type of processor, controller, microcontroller, or state machine. The processor may alternatively be implemented by a combination of computing apparatuses, such as a digital signal processor and a microprocessor, a plurality of microprocessors, one or more microprocessors with a digital signal processor core, or any other similar configuration.

Steps of the methods or algorithms described in embodiments of the present disclosure may be directly embedded into hardware, a software unit executed by a processor, or a combination thereof. The software unit may be stored in a RAM storage, a flash memory, a ROM storage, an EPROM storage, an electronically-erasable programmable EEPROM storage, a register, a hard disk, a removable magnetic disk, a CD-ROM, or a storage medium of any other form in the art. For example, the storage medium may be connected to a processor, so that the processor may read information from the storage medium and write information to the storage medium. Optionally, the storage medium may alternatively be integrated into a processor. The processor and the storage medium may be disposed in an ASIC.

These computer program instructions may alternatively be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although the present disclosure is described with reference to specific features and embodiments thereof, it is clear that various modifications and combinations may be made to them without departing from the spirit and scope of the present disclosure. Correspondingly, the specification and accompanying drawings are merely example descriptions of the present disclosure defined by the appended claims, and are considered as any of or all modifications, variations, combinations or equivalents that cover the scope of this application. It is clear that a person skilled in the art can make various modifications and variations to the present disclosure without departing from the scope of this application. This application is intended to cover these modifications and variations of the present disclosure provided that they fall within the scope of protection defined by the following claims and their equivalent technologies.

What is claimed is:

1. A method performed by one or more processors in a computing device comprising first, second, and third register groups and a matrix computation circuitry, the method comprising:
obtaining to-be-calculated polynomials in a polynomial calculation application;
dividing the to-be-calculated polynomials to obtain to-be-calculated groups, wherein each of the to-be-calculated groups comprises at least one to-be-calculated polynomial that has a same variable coefficient;
determining a respective common variable, a respective variable coefficient, and a respective reference variable that correspond to each of the at least one to-be-calculated polynomial in a first to-be-calculated group of the to-be-calculated groups;
loading the respective common variable a first register group,
loading the respective variable coefficient to a second register group;
loading the respective reference variable to a third register group;
controlling, by the matric computation circuitry, outer product calculation to be performed on the respective common variable in the first register group and the respective, variable coefficient in the second register group to obtain a first result corresponding to each of the at least one to-be-calculated polynomial; and
controlling, by the matrix computation circuitry, inner product calculation to be performed on the first result and the respective reference variable in the third register group to obtain a second result corresponding to each of the at least one to-be-calculated polynomial.

2. The method of claim 1, wherein determining the respective common variable, the respective variable coefficient, and the respective reference variable comprises:
from a first polynomial in the at least one to-be-calculated polynomial, M N^{th}-degree polynomials and M reference variables corresponding to the M N^{th}-degree polynomials, wherein the M N^{th}-degree polynomials are in one-to-one correspondence with the M reference variables, wherein each N^{th}-degree polynomial comprises N common variables and N variable coefficients, wherein the N common variables are in one-to-one correspondence with the N variable coefficients, wherein the N common variables in each of the M N^{th}-degree polynomials are the same, wherein M is a positive integer, wherein N is a first integer greater than 1, and wherein the first polynomial is any polynomial in the at least one to-be-calculated polynomial; and
determining the N common variables and M*N variable coefficients based on the M N^{th}-degree polynomials.

3. The method of claim 2, wherein before extracting the M N^{th}-degree polynomials and the M reference variables, the method further comprises:
determining that degrees of monomials in the first polynomial are non-consecutive; and
supplementing, in response to determining that the degrees are non-consecutive, the first polynomial with a monomial corresponding to a missing degree, wherein a variable coefficient of the monomial is zero.

4. The method of claim 2, wherein before extracting the M N^{th}-degree polynomials and the M reference variables, the method further comprises:
determining that a number of monomials in the first polynomial is odd; and
supplementing, in response to determining that the number is odd, the first polynomial with an odd number of monomials, wherein variable coefficients of the odd number of monomials are all zero.

5. The method of claim 2, wherein extracting, the M N^{th}-degree polynomials and the M reference variables comprises:
obtaining M second polynomials using every N monomials of adjacent degrees in the first polynomial as one second polynomial;
determining respective ratios of a k^{th} variable in each of the M second polynomials to a k^{th} variable comprised in a second polynomial of a lowest degree as the M reference variables, wherein k is a nonnegative integer less than N; and
determining ratios of each of the M second polynomials to corresponding reference variables in the M reference variables as the M N^{th}-degree polynomials.

6. The method of claim 2, wherein loading the respective common variable to the first register group, loading the respective variable coefficient to the second register group, and loading the respective reference variable to the third register group comprises:
loading the N common variables corresponding to the first polynomial to a first destination register group of the first register group;
loading the M*N variable coefficients corresponding to the first polynomial to a second destination register group of the second register group; and
loading the M reference variables corresponding to the first polynomial to a third destination register group third register group.

7. The method of claim 6, wherein the first destination register group comprises first registers, wherein each of the first registers comprises storage locations, and wherein loading the N common variables to the first destination register group comprises loading an i^{th} common variable in the N common variables to a j^{th} storage location in a (b+i)^{th} first register in the first destination register group, and wherein i is a second integer in [0, N−1], j is a first nonnegative integer, and b is a second nonnegative integer.

8. The method of claim 6, wherein the second destination register group comprises second registers, wherein each of the second registers comprises storage locations, and wherein loading the M*N variable coefficients to the second destination register group comprises loading an i^{th} variable coefficient corresponding to an m^{th} N^{th}-degree polynomial in the M N^{th}-degree polynomials to a (b+m)^{th} storage location in a (b+i)^{th} second register in the second destination register group, wherein m is a second integer in [0, M−1], i is a third integer in [0, N−1], and b is a nonnegative integer.

9. The method of claim 6, wherein the third destination register group comprises third registers, wherein each of the third registers comprises storage locations, and wherein loading the M reference variables to the third destination register group comprises loading an m^{th} reference variable in the M reference variables to a j^{th} storage location in a (b+m)^{th} third register in the third destination register group, and wherein m is a second integer in [0, M−1], b is a first nonnegative integer, and j is a second nonnegative integer.

10. The method of claim 6, wherein controlling the outer product calculation to obtain the first result comprises controlling the outer product calculation to be performed on a common variable in the first destination register group and a variable coefficient in the second destination register group to obtain the first result corresponding to the first polynomial.

11. The method of claim 10, wherein controlling the inner product calculation to obtain the second result comprises controlling the inner product calculation to be performed on the first result corresponding to the first polynomial and a reference variable in the third destination register group to obtain the second result corresponding to the first polynomial.

12. An apparatus, comprising:
a memory configured to store instructions; and
one or more processors coupled to the memory and configured to execute the instructions to causes the apparatus to:
obtain to-be-calculated polynomials in a polynomial calculation application;
divide the to-be-calculated polynomials to obtain to-be-calculated groups, wherein each of the to-be-calculated groups comprises at least one to-be-calculated polynomial;
determine a respective common variable, a respective variable coefficient, and a respective reference variable that correspond to each of the at least one to-be-calculated polynomial in a first to-be-calculated group of the to-be-calculated groups, wherein the at least one to-be-calculated polynomial corresponds to a same variable coefficient;
load the respective common variable to a first register group,
load the respective variable coefficient to a second register group;
load the respective reference variable to a third register group;
control outer product calculation to be performed on the respective common variable in the first register group and the respective variable coefficient in the second register group; to obtain a first result corresponding to each of the at least one to-be-calculated polynomial; and
control inner product calculation to be performed on the first result and the respective reference variable in the third register group to obtain a second result corresponding to each of the at least one to-be-calculated polynomial.

13. The apparatus of claim 12, wherein the one or more processors further execute the instructions to cause the apparatus to further determine the respective common variable, the respective variable coefficient, and the respective reference variable by:
from a first polynomial in the at least one to-be-calculated polynomial, M Nth-degree polynomials and M reference variables corresponding to the M Nth-degree polynomials, wherein the M Nth-degree polynomials are in one-to-one correspondence with the M reference variables, wherein each Nth-degree polynomial comprises N common variables and N variable coefficients, wherein the N common variables are in one-to-one correspondence with the N variable coefficients, wherein the N common variables in each of the M Nth-degree polynomials are the same, wherein M is a positive integer, wherein N is a first integer greater than 1, and wherein the first polynomial is any polynomial in the at least one to-be-calculated polynomial; and
determining the N common variables and M*N variable coefficients based on the M Nth-degree polynomials.

14. The apparatus of claim 13, wherein the one or more processors further execute the instructions to cause the apparatus to:
determine that degrees of monomials in the first polynomial are non-consecutive; and
supplement, in response to determining that the degrees are non-consecutive, the first polynomial with a monomial corresponding to a missing degree, wherein a variable coefficient of the monomial is zero.

15. The apparatus of claim 13, wherein the one or more processors further execute the instructions to cause the apparatus to:
determine that a number of monomials in the first polynomial is odd; and
supplement, in response to determining the number is odd, the first polynomial with an odd number of monomials, wherein variable coefficients of the odd number of monomials are all zero.

16. The apparatus of claim 13, wherein the one or more processors further execute the instructions to cause the apparatus to further extract the M Nth-degree polynomials and the M reference variables by:
obtaining M second polynomials using every N monomials of adjacent degrees in the first polynomial as one second polynomial;
determining respective ratios of a kth variable in each of the M second polynomials to a kth variable comprised in a second polynomial of a lowest degree as the M reference variables, wherein k is a nonnegative integer less than N; and
determining ratios of each of the M second polynomials to corresponding reference variables in the M reference variables as the M Nth-degree polynomials.

17. The apparatus of claim 13, wherein the one or more processors further execute the instructions to cause the apparatus to load the respective common variable to the first register group, load the respective variable coefficient to the second register group, and load the respective reference variable to the third register group by:
loading the N common variables corresponding to the first polynomial to a first destination register group of the first register group;
loading the M*N variable coefficients corresponding to the first polynomial to a second destination register group of the second register group; and
loading the M reference variables corresponding to the first polynomial to a third destination register group of the third register group.

18. The apparatus of claim 17, wherein the first destination register group comprises first registers, wherein each of the first registers comprises storage locations and wherein the one or more processors further execute the instructions to cause the apparatus to further load the N common variables to the first destination register group by: loading an ith common variable in the N common variables to a jth storage location in a (b+i)th first register in the first destination register group, and wherein i is a second integer in [0, N−1], j is a first nonnegative integer, and b is a second nonnegative integer.

19. The apparatus of claim 17, wherein the second destination register group comprises second registers, wherein each of the second registers comprises storage locations, and wherein the one or more processors further execute the instructions to cause the apparatus to further load the M*N variable coefficients to the second destination register group by: loading an ith variable coefficient corresponding to an mth Nth-degree polynomial in the M Nth-degree polynomials to a (b+m)th storage location in a (b+i)th second register in the second destination register group, wherein m is a second integer in [0, M−1], i is a third integer in [0, N−1], and b is a nonnegative integer.

20. The apparatus of claim 17, wherein the third destination register group comprises third registers, wherein each of the third registers comprises storage locations; and wherein the one or more processors further execute the instructions to cause the apparatus to further load the M reference variables to the third destination register group by: load an m^{th} reference variable in the M reference variables to a j^{th} storage location in a (b+m)^{th} third register in the third destination register group, wherein m is a second integer in [0, M−1], b is a first nonnegative integer, and j is a second nonnegative integer.
